(19) United States
(12) Patent Application Publication
(10) Pub. No.: US 2015/0046239 A1
(43) Pub. Date: Feb. 12, 2015

(54) Pooling Business Credits to Provide Cross-Redemption Options of Business-Specific Credits

(71) Applicant: Clearbon Inc, San Francisco, CA (US)

(72) Inventors: Anthony C. Di Franco, Berkeley, CA (US); Adalbert J. Wysocki, San Francisco, CA (US); Arno Hesse, San Francisco, CA (US); Guillaume P. Lebleu, San Francisco, CA (US)

(21) Appl. No.: 14/454,623

(22) Filed: Aug. 7, 2014

Related U.S. Application Data
(60) Provisional application No. 61/863,290, filed on Aug. 7, 2013.
(60) Provisional application No. 61/929,898, filed on Jan. 21, 2014.

(51) Int. Cl. G06Q 30/02; G06Q 20/40

(52) U.S. Cl. CPC G06Q 30/0215; G06Q 30/0238; G06Q 20/40; G06Q 30/0225
USPC 705/14.17

(57) ABSTRACT

Systems and methods enable creation of assets redeemable for products and services for businesses. Business credits are assigned to users and applied toward transactions. Business credits from different businesses may be pooled and applied toward a single transaction. Rules for business credits may limit amounts that may be added to a pool. A users assets are ranked to determine those that are preferred to hold. Those assets that are available to fund a transaction and that are less preferable to hold are used first. Also disclosed is a system whereby brand-specific credits may be assigned to a user. A brand-specific credit may be selected and, in-response, branded products for which the credit may be redeemed are displayed. Upon selection of a product, an optical code is transmitted to a user device, which can be scanned to fund purchase of the selected product.

### CROSS REFERENCE TO RELATED APPLICATIONS

This application claims the priority benefit of U.S. Provisional Application Ser. No. 61/863,290, entitled “Pooling Business Credits to Provide Cross-Redemption Options of Business-Specific Credits”, filed Aug. 7, 2013, the disclosure of which is incorporated by reference herein in its entirety. This application also claims the priority benefit of U.S. Provisional Application Ser. No. 61/929,898, entitled “System and Method for Redeeming a Balance of Brand-Specific Credits at a General Retail Store”, filed Jan. 21, 2014, the disclosure of which is incorporated by reference herein in its entirety

### BACKGROUND

1. Field of the Invention

This invention relates to systems and methods for providing and redeeming credits by businesses.

2. Background of the Invention

Business credits, also known as store credits, defined as a balance issued by a business and redeemable for the business's goods and services, are a common tool used by businesses to reward customer loyalty, to compensate a product return, to allow a customer to make a gift to another person, and to provide discounts for bulk purchases paid in advance. In the past, such credits may have been issued in the form of a paper certificate or card but are increasingly provided in pure electronic form as an account accessible online via a secret code with a balance denominated in the currency of the country where it is issued. Electronic forms of business credits have facilitated the emergence of services that provide aggregated access to store-specific credit account balances in a single mobile application or online service.

Typically a business credits balance is business-specific, where it is issued by a specific business and is only redeemable at the same specific business that issued it. When a business is owned by the same legal entity, the balance of the business credit account may be redeemable at any of the locations of the company.

In some cases, business credits can be redeemed at multiple businesses owned by different legal entities. This is typical of business credit available for purchase from malls or other business coalitions like chambers of commerce. In these cases, the business credits balance is typically not really issued by any of the accepting businesses, but by a third party company called a program operator. The program operator sells its own business credit balances it issued to interested businesses for a fee in addition to the face value of the business credits balance. The face value and/or fee may be collect and deposit by the program operator as bank credits in a FDIC bank account until the business credits balance is redeemed at a store. Upon redemption, the cross-redeemable business credit program operator buys back the collected business credits from the redeeming business and transfers back the amount redeemed in bank credits by bank transfer to the redeeming business. If participating businesses themselves sell the cross-redeemable business credits, amounts sold by a business and owed to the program operator may be netted against business credits collected and purchased by the program operator and owed to the business. In some cases, the third party program operator is a bank and cross-redeemable business credits are essentially restricted-use bank credits and the business credits balance is issued in the form of a bankcard whose redemption is restricted to the participating businesses.

These latter cases, where cross-redeemability of business credits is made possible by a third-party operator selling and buying back its business credits for bank credit, are not advantageous to the participating businesses. Among other reasons, participating businesses do not retain the value of the amount of business credits balance that is never redeemed (termed breakage). Also, when the business credits balance is sold for bank credit, the business does not get the benefit of receiving the bank credit upfront. And, if the business credits balance is issued as a reward, it is an immediate cash cost to the business, rather than a future reduced margin on a future sale in which business credits are used.

The systems and methods described herein provide an improved approach for issuing business credits to customers and redeeming such credits.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing methods in accordance with an embodiment of the present invention;

FIG. 2 is a schematic block diagram of data structures suitable for implementing methods in accordance with an embodiment of the present invention;

FIG. 3 is a process flow diagram of a method for determining a customer's purchasing power with respect to a business in accordance with an embodiment of the present invention;

FIG. 4 is a process flow diagram of a method for ranking assets in accordance with an embodiment of the present invention;

FIG. 5 is a process flow diagram of a method for processing a transaction in accordance with an embodiment of the present invention;

FIGS. 6A and 6B are example interfaces for displaying assets in accordance with an embodiment of the present invention;

FIGS. 7A and 7B are example interfaces for displaying detailed attributes of an asset in accordance with an embodiment of the present invention;

FIGS. 8A to 8C are example interfaces for funding a transaction using assets in accordance with an embodiment of the present invention;

FIGS. 9A to 9C are example interfaces for redeeming assets in accordance with an embodiment of the present invention;

FIG. 10 is an example interfaces for receiving ranking of assets in accordance with an embodiment of the present invention;

FIGS. 11A and 11B are example interfaces for viewing customer assets in accordance with an embodiment of the present invention;

FIGS. 12A to 12C are example interfaces for verifying a customer by a cashier in accordance with an embodiment of the present invention;

FIG. 13 is an example interface for receiving asset parameters in accordance with an embodiment of the present invention;

FIG. 14 is an example interface for receiving asset usage parameters in accordance with an embodiment of the present invention;

FIG. 15 is an example interface for receiving additional asset usage parameters in accordance with an embodiment of the present invention;

FIG. 16 is an example interface fir receiving additional asset usage parameters in accordance with an embodiment of the present invention;

FIG. 17 is an example interface for receiving pool configuration parameters in accordance with an embodiment of the present invention;

FIG. 18 is a process flow diagram of a method for funding a transaction from a pool in accordance with an embodiment of the present invention;

FIG. 19 is a schematic block diagram of a network environment for implementing redemption of brand-specific credits in accordance with an embodiment of the present invention;

FIG. 20 is a process flow diagram of a method for redeeming brand-specific credits in accordance with an embodiment of the present invention;

FIGS. 21A and 21B are example interfaces for viewing brand-specific credits in accordance with an embodiment of the present invention;

FIG. 22 is an example interface for presenting a retail location in accordance with an embodiment of the present invention;

FIGS. 23A and 23B are example interfaces for finding brand-specific products in accordance with an embodiment of the present invention;

FIGS. 24A and 24B are example interfaces for selecting a product for purchase in accordance with an embodiment of the present invention;

FIGS. 25A and 25B are example interfaces for reporting an insufficient balance in accordance with an embodiment of the present invention;

FIG. 26 is an example interface for verifying a product selection in accordance with an embodiment of the present invention;

FIG. 27 is an example interface for presenting a coupon code in accordance with an embodiment of the present invention; and

FIG. 28 is a schematic block diagram of a computer system suitable for implementing methods in accordance with embodiments of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been hilly solved by currently available apparatus and methods. In one embodiment, an approach is provided where one or more businesses issues their own business-specific credits balance to individual parties and then provides the ability to each individual party to deposit all or part of the business-specific credits they′ hold into a pool alongside several other parties, receive a balance in the pool, and later withdraw any business-specific credits available in the pool, up to their balance in the pool, thereby providing options to redeem their business-specific credits at other businesses than the one who issued them. The deposit to the pool may also be a way for depositors of business-specific credits to spread the risk that a business defaults on their issued business credit, in accordance with the operating rules of the pool.

Furthermore, a system is provided that facilitates the setup and operation of a pool, including for example deposits, withdrawals, real-time view of cross-redeemability options for any′ party participating in a pool, and enforcement of the operating rules of the pool regarding how loss is extinguished among pool depositors when a business defaults on business credits it issued that were deposited in the pool.

For business parties issuing business credits and selling them for bank credit or cash for instance as prepaid or as gift certificate, one approach provides their business credit holders with cross-redeemability options while giving the issuing business party the benefit of receiving the bank credit or cash at the time the business credits balance is sold rather than at the time the business credits are redeemed. Similarly, for business parties issuing business credits as rewards, one example may provide their business credits holders with cross-redeemability options while avoiding the issuing party a cash outflow at the time the business credits balance is issued, and instead only incurring a reduced margin at the time of redemption of the business credits.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

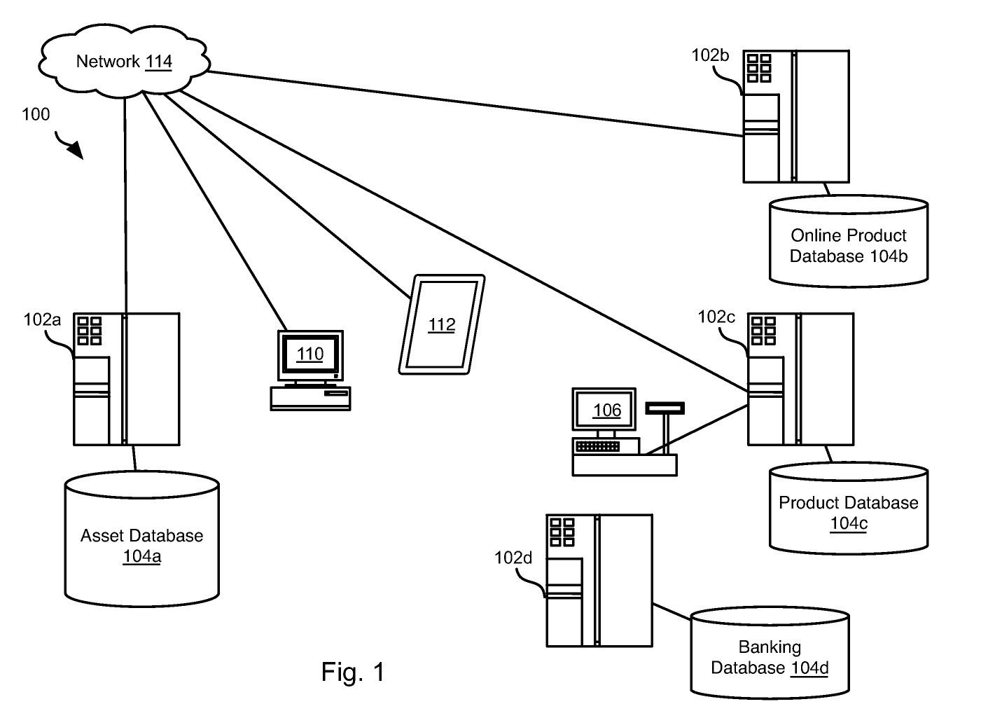

FIG. 1 illustrates a network environment 100 in which the systems and methods disclosed herein may be implemented. In particular, the methods disclosed herein may be performed by a server system 102a in cooperation with computer systems of other entities. The server system 102a may host or access an asset database 104a storing assets as defined hereinbelow.

Business credits as defined and processed as described herein may be issued by an online retailer operating a server system 102b for processing online transactions with respect to an online product database 104b. Business credits as defined and processed as described herein may be issued by a retailer operating a server system 102b for recording and/or processing transactions conducted on a point of sale (POS) device 106 operated at a physical store with respect to a product database 104b.

In some embodiments, business credits as defined and processed according to the methods disclosed herein may be combined with credits from a financial institution, i.e. credits from a credit card, checking account, savings account, or the like. Accordingly, a server system 102d of a financial institution and hosting and/or accessing a banking database 104d defining bank account information for a plurality of customers may also interact with the server system 102a.

Customers may view and redeem credits from a computing device 110, 112 such as a laptop or desktop computing device 110 or a mobile computing device 112 such as a smart phone, tablet computer, wearable computer, or some other computing device.

The server systems 102a-102d and computing devices 110, 112 may communicate with one another through a network 114, such as the Internet, a local area network (LAN), wide area network (WAN), or some other network. Communication between devices may be over a wired or wireless connection and may occur using any networking protocol known in the art.

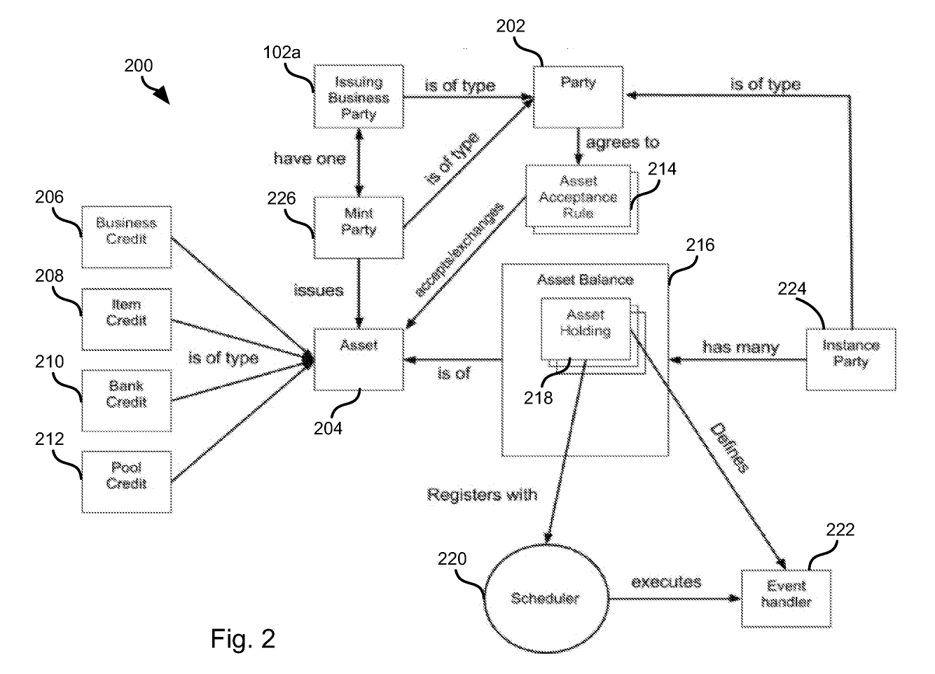

Referring to FIG. 2, the methods disclosed herein may implement an approach for dealing with business credits that makes use of the illustrated object model 200.

One example of such an approach includes:
(a). A party object model 202 representing the different types of parties and their role in the system.
(b). An asset object model 204 to represent the common properties of different types of credits supported by the system: credits redeemable at a business (business credit, item credit, bank credit) as well as pools of pool credit.
(c). A business credit object model 206 to represent instances of business-specific credits as a contract between an issuing business party and a holding party specifying the operating rules of the business credit, also known as terms and conditions, throughout its lifecycle, from authorization, to issuance, to maturity, to redemption or expiration (“business credit object model”). For purposes of this disclosure, business credits are credits issued by a business that is not a financial institution, i.e. that sells a product or service other than banking and financial services.
(d). An item credit object model 208 to represent credits redeemable for specific items at a business as a contract between an issuing business party and a holding party specifying the operating rules, also known as terms and conditions, throughout its lifecycle, from authorization, to issuance, to maturity, to redemption or expiration (“item credit object model”).
(e). A bank credit object model 210 to represent credits redeemable from a bank for cash as a contract between the issuing business party (the bank) and the holding party.
(f). A pool object model 212 to represent instances of pools of business credits each as a contract between pool depositing parties specifying the business credits that can be deposited in the pool as well the operating rules of the pool throughout the pool lifecycle from deposits of business credits to withdrawal, to handling of defaulting of business credits in the pool (“pool object model”).
(g). An asset lifecycle management algorithm updating according to the asset's operating rules the quantity of each asset held or issued by each party in the system. This quantity is called the balance of the party in the asset.
(h). An asset acceptance rules object model 214 representing the assets that a business accepts to redeem in exchange for its goods and services, in addition to the business credits and item credit it issued.
(i). A purchasing power algorithm computing the maximum amount that a party can redeem at a business given all the assets that she or he holds (item credits, bank credits, business credits issued by the business transacted with, business credits not issued but accepted by the business transacted with, pool credits from which business credits can be withdrawn and accepted by the business transacted with).
(j). An asset holding preference algorithm inferring the preference of a party to hold a given asset over another, based on the operating rules of each asset held and the preferences of the party holding the assets.
(k). An asset allocation algorithm allocating which of a transacting party's assets to redeem to fund a given transaction at a given business, based on the asset holding preferences of the transacting party.
(l). A business owner user interface to create and edit business credits, item credits, bank credits.
(m). A pool administrator user interface to create and edit instances of the asset object model
(n). A consumer user interface through which a party holding assets can view the balance available to them in each asset, view their purchasing power at each store based on all the assets she or he holds, join one or more pools and deposit business-specific credit in them, set asset holding preferences, view how its various assets would be allocated to fund a particular redemption transaction, and initiate a redemption transaction at a given business.
(o). A point-of-sale (POS) user interface through which a business employee can view the purchasing power of a party at the store based on all the assets the party holds, and initiate a redemption transaction of the party's asset at the store.

In some embodiments, an asset balance 216 of a user, which may include asset holdings that are defined according to one of the credit object models 206-212 may be updated and processed by a scheduler 220 that performs tasks defined according to the object models 206-212. An even handler 222 may receive events from businesses or customers that create, modify, or redeem assets 218. The credit models 206-212 may define functions to be executed in response to events received and such tasks may be invoked by the event handler, such as by scheduling execution thereof by the scheduler 220.

The scheduler 220, even handler 222, and/or one or more modules executed or accessed by the server system 102a may implement the purchasing power algorithm, asset holding preference algorithm, asset allocation algorithm, business owner user interface, pool administrator user interface, consumer user interface, and POS user interface as described in points (l) through (p) in the list above and as described in greater detail below.

The asset balance 216 and corresponding assets may be part of an account of an instance party 224, i.e. an instance of the party object model 202 corresponding to a particular customer. Likewise, a mint party 226 may be a party that issues business credits, i.e. a business.

Detailed information for the various object models mentioned are above is provided below. The functionality of the various object models described below may be implemented or enforced by the server system 102a when processing transactions using assets or performing other activities with respect to assets generated by a business or assigned to a consumer.

### The Part Object Model 202

Each individual person or organization may be represented as a party. The properties of the party object model 202 may include some or all of
Party Name (string): the name of the party.
Party Type: either “business”, “mint” or “individual”
   “individual” or “consumer” is a party without productive capacity, thus not issuing credits, because it cannot back them with redeemable goods and services it produces, but instead buying, earning and redeeming business credits,
   “business” is a party with productive capacity, able to back credits it issues with redeemable goods and services it produces. Thus in the system described, a business is typically but may not be an incorporated business.
   “mint” is a party authorizing asset issuance. The mint may be a the same party as the business party in the case of business credits issuance, or a governance body of the business party in the case of a business credits issuance such as a board of directors, or an unincorporated group of parties agreeing to the pool's operating rules in the case of pool credits issuance, or the governance body of an incorporated group of parties in the case of pool credits issuance,

### The Asset Object Model 204

The asset object model 204 represents as contracts the various types of credit redeemable at a business. Instances of the asset object model 204 may be created by business and assigned to a consumer, i.e. the business may instruct the server system 102a to generate an asset object and associate the asset object with the account of the consumer. Some or all assets may share a common set of properties, which may include some or all of:
Asset Name (string): the name of the asset type (ex. “Slorise Rewards”)
Asset Type (enumeration): “store credit”, “pool”, “bank credit”, “item credit”.
Authorizer: the party authorizing the asset (ex. “Clearbon Employees Pool Administrator”).
Accounting Unit (enumeration): how the asset is accounted for (ex. a local monetary unit like the USD, or a physical unit like pounds or gallons of a certain good (e.g. “pounds of sausage”) or hours of a certain kind of labor (e.g. “hours of legal services”), or as a unit in itself incommensurable in value with anything else (“each”)
Terms (long text): the human-readable legal terms.
A balance may be defined as a relationship between a party and an asset. It is composed of one or more holdings (e.g. an amount of currency or some other unit of exchange) each referencing the issuance timestamp of the asset to the receiving party.

### The Business Credit Object Model 210

The business credit object model represents instances of store-specific store credits as a contract between an issuing business party and a holding party specifying the operating rules, also known as terms and conditions, throughout the business credit lifecycle, from authorization, to issuance, to maturity, to redemption or expiration (“business credit object model”).

The business credit object model may extend the asset object model with some or all of the following properties:
Issuer (business identifier): the party issuing the authorized asset and accepting to redeem them for its goods and services (ex. “Slorise LLC”)
Operating rules:
   Quantity available:
      Quantity limit (decimal): How many units of the assets have been authorized.
      Quantity available (decimal): Quantity limit minus quantity issued and outstanding (if null, no limit).
      Quantity limit per customer (decimal): how many units a single party can hold of the asset at any time (if null, no limit).
   Deferred availability/Maturity
      Maturity (Boolean): is the asset immediately redeemable, or does the holder need to wait until the asset matures. (ex. farm notes are issued in Autumn but redeemable at harvest the year after)
      Maturity period (time interval): after how long does the asset mature after purchase date.
      OR Maturity date (date/time) and Purchase Cutoff date: on which specific date does the asset matures and when can it be purchased at the latest.
   Periodic availability
      Periodic deposits (Boolean): can the amount of asset issued only be redeemed in portions, each portion being deposited at each time interval?
      Portion deposited per interval (%): the % of the amount issued that is actually deposited per interval.
      OR Portion deposited per interval (decimal): an amount in asset type unit
      Interval for periodic depositing (time interval): how much time elapses between each portion deposit.
   Redemption limits:
      Max redemption per transaction (Boolean): whether the redemption of the asset is subject to a limit per transaction.
      Max redemption per transaction (%): the maximum % of the total transaction purchase that can be redeemed with this asset for a given transaction (assuming remainder is bank credit or cash).
      OR Max redemption per transaction (decimal): the maximum amount that can be redeemed with this asset for a given transaction (assuming remainder is bank credit or cash).
      Periodic withdrawal limit (decimal). whether redemption is limited to a certain amount by day, week, month.
   Transferability (Boolean): is the asset transferable to a party other than the one who issued it.
   Refundability
      Refundable (Boolean): is the asset refundable partially or in full and during which time frame
      Refund time frame (time interval relative to expiration period or expiration date)
      Maximum refund amount (decimal)
   Dormancy
      Dormancy fee (Boolean): does the asset incur a fee for not being used?
      Dormancy fee (decimal): the fee amount in the asset unit.
      Dormancy period: after how long of not being used does the asset starts to incur a dormancy fee.
      Dormancy fee period: once dormancy period has been reached, how often does the dormancy fee is incurred.
   Expiration
      Expires (Boolean): does the asset expire?
      Expiration period (time interval): after how long does the asset expire after it was credited?
      OR Expiration date/time: when does the asset expire (cannot be combined with expiration period)

### Item Credit Object Model 208

The item credit object model 208 may extend the business credit object model 206 with some or all of the following operating rules:
Item restrictions: unique identifier of the item, such as a universal product code (UPC) for a product, or a location and date/time for a service.

In addition, any instance of the item credit object model has an accounting unit of “each”.

### Bank Credit Object Model 210

The bank credit object model 210 may extend the base asset object mode 204 with some or all of the following properties:
Bank external identifiers (e.g. routing number)
Balances of parties in bank credit are annotated with identifiers of the corresponding account at the bank.
The accounting unit of bank credits may always be the local official currency where the bank credits are issued (ex. USD in USA).

### Pool Object Model 212

The pool object model represents instances of pools of credits as a contract between pool participants specifying the credits authorized in the pool as well the operating rules of the pool throughout the pool lifecycle from deposits of credits to withdrawal of credits to handling of defaulting of business credits in the pool.

The pool object model may extend the asset object model with some or all of the following properties:
Operating rules:
Ordered list of default/expiration handling rules, which specifies how the loss should be split between pool asset holders should a given asset in the pool lose its value because of a default of the issuing party or the asset expiring. This is an ordered list because the execution of a single default/expiration handling rule may not extinguish fully the loss and multiple rules may be executed until the loss is fully extinguished. The rules are:
   Proportional. The pool loses all that it has of the defaulting asset. The corresponding amount is subtracted from each of the members pool balances proportional to the total pool balance that they own. This rule can be used to extinguish any loss and is always required as a rule of last resort when other default/expiring rules are executed first.
   Equal per capita: The loss is the same for all pool asset holders. Maximum loss per pool asset holding party is determined by the asset holding party in the pool with the least non-zero pool balance. The loss amount is subtracted from each holding party's pool asset balance. This rule may not sufficient to fully extinguish the loss.
   Last in First Out (LIFO): the loss is borne by the pool asset holding party who has last deposited the defaulting asset into the pool, recursively until the loss is fully extinguished or no more holders who have deposited units of the defaulting asset can be found. This rule may not sufficient to fully extinguish the loss.
   Fee: Each contribution to a pool, or redemption from the pool is charged a proportional fee or other fee, which is held in reserve by the pool to offset losses resulting from future defaults. The reserve accumulated through fees may not in itself be sufficient to hilly extinguish losses,
   Loss limited to depositor's option: an option of the LIFO, proportional and equal per capita rules. If this option is turned on, losses are limited to the holders of the defaulting assets who contributed the defaulting asset to the pool, not the holders of the defaulting asset who merely received it from another asset holder, after it was contributed to the pool.
   Clawback option: an option of the LIFO, proportional and equal per capita rules. Losses for each pool asset holder who has contributed to the pool the defaulting asset is not limited to their pool asset balance, but can include assets that are held outside of the pool. Even rules executing with the clawback option set may not be sufficient to fully extinguish the loss.
One ore more acceptance rules as defined in section h. specifying which assets are accepted by the pool in exchange for pool credits issued.

### Asset Lifecycle Management Algorithm

The asset lifecycle management algorithm may execute the operating rules of an asset in response to relevant lifecycle events referencing the asset, such as events received by the event handler 222. Upon the issuance event of a balance of an asset to a party, the asset lifecycle management algorithm registers with the scheduler 220 the relevant future lifecycle events of the asset. The relevant events may include some or all of
Authorization: the mint party of the asset authorizes the issuance of the asset and transfers the authorized amount to either:
   the business party who will back the asset by promising to redeem its goods and services in exchange for the asset, resulting in the balance of the mint in the asset and the balance of the business in the asset, to respectively decrease (going negative) and increase by the same amount.
   in the case of a pool, the party who deposited assets into the pool.
Issuance: the business party transfers an amount of the asset it issues to another party other than the mint, resulting in the balance of the business in the asset, and the balance of the receiving party in the asset, to respectively decrease (but never go negative) and increase by the same amount. The process involves the creation of a new asset holding for the receiving party with an issuance timestamp. At this moment, the asset holding registers lifecycle events handlers to a scheduler such that they can be invoked by the scheduler upon later occurrence.
Maturity: the balance of the party in the asset is increased by the entire value of the holding in question to reflect the maturation of that holding.
Periodic maturity: same as maturity, but multiple maturity events occur in sequence over time with each one reflecting the maturation of a portion of the holding until the entire holding has matured and the full balance of the holding is made available.
Dormancy: the balance of the party in the asset is decreased by an amount determined by the amount of time since the last transaction in the asset or the amount of time since acquisition of the holding or a function of both.
Expiration: the balance of the party is reduced to zero at a globally fixed time or after a specific length of time after acquisition of the holding.
Default: the balance of the party is reduced to zero due to the unforeseen inability of its issuer to honor the promise it represents, reflected in the accounting system by an ad-hoc event. Special logic is applied in the case of a balance held by a pool.

### Asset Acceptance Rules Object Model

An asset acceptance rule is a way for a party to specify which asset they accept either for redemption for goods and services or for exchange with another asset. A business always accepts the business credit or item credit it issued up to the amount outstanding that is to say issued but not redeemed, but may accept other assets than the one it issued.

The asset acceptance rule object model is defined as follows:
Which asset(s) is accepted by the party specifying the acceptance rule. All assets accepted must share the same accounting unit. Accepted assets can be of any type supported by the system: business credits, pool credits, item credits.
In exchange for which asset(s) held by the party specifying the acceptance rule. If multiple assets, all assets exchanged must share the same account unit. For a business, this may include goods and/or services provided by the business. Accepted assets can be of any type supported by the system: business credits, pool credits, item credits.
An explicit party or parties from whom the assets will be accepted. Optional, and if not specified, any other party may transact in the specified way.
An exchange rate of equivalence between each asset accepted and offered.
Maximum amount of the asset(s) exchanged in a transaction.
Minimum amount of the asset(s) exchanged in a transaction.
Beginning time of validity of acceptance rule
End time of validity of acceptance rule, absolute or relative to beginning

In case several rules match, the rules are applied to maximize transaction amounts, in decreasing order of preference of the accepted asset to the accepting party,

### Purchasing Power Algorithm

The purchasing power algorithm computes the maximum amount in the local monetary unit or a given arbitrary unit that a party can redeem at a business given all the assets issued or accepted by the business that it holds directly or can withdraw from the pool(s) it holds receipts for.

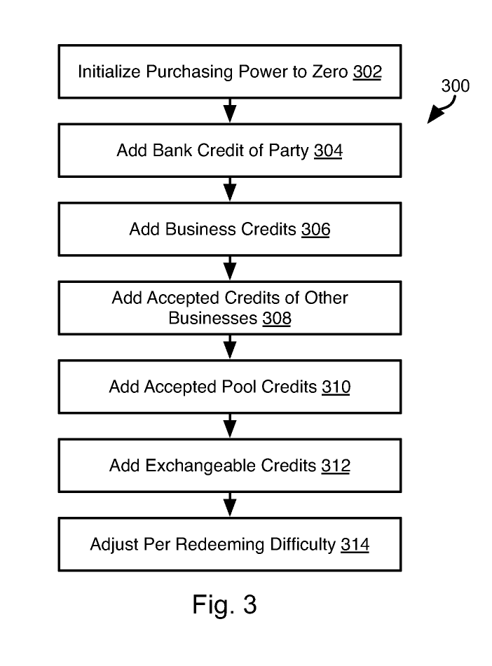

The purchase power algorithm computes the maximum amount that a party can redeem at a business as shown in the method 300 of FIG. 3. For example, for a particular instance party, the purchasing power of the instance party may be initialized 302 to zero. Any bank credits of the instance party denominated in the local monetary unit that the instance party holds is added 304 to the purchasing power. Business credits of the instance party are added 306 to the purchasing power denominated in the local monetary unit that the party holds and that the business issued.

The method 300 may include adding 308 any business credits denominated in the local monetary unit that the party holds and that the business didn't issue but that the business accepts for goods and services according to the asset acceptance rules specified by the business.

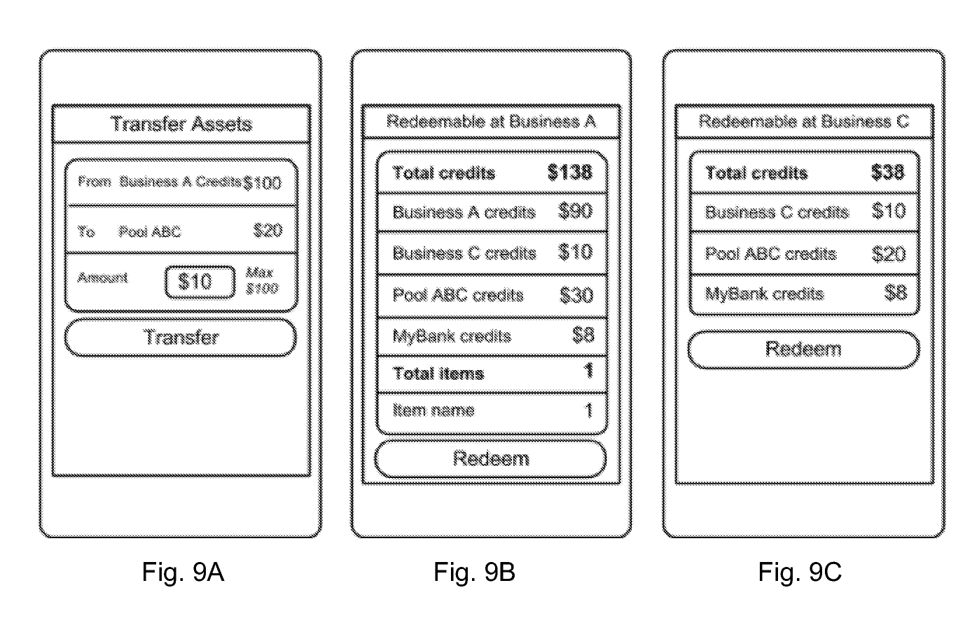

The method 300 may include adding 310 any business credits denominated in the local monetary unit that the business issued or accepts, that the party can withdraw from the pool credits he or she holds. As illustrated in FIG. 9C, a redeeming party may have $30 balance in a “Pool. ABC credits” pool, but the pool may only contain $20 credits issued by the accepting business, limiting the redemption value of $30 “Pool ABC credits” to $20 at the accepting business party.

The method 300 may include adding 312 any business credits denominated in the local monetary unit that can currently be exchanged according to the acceptance rules specified by any party in the system for business credits that the business issued or accepts for goods and services.

In some embodiments, 300 one or more of the terms added according to the method 300 may be adjusted 314, i.e. reduced, by an amount that increases with the difficulty of executing the corresponding transactions.

The buying power as computed may be stored in association with a user account, transmitted for display on the user's device, transmitted to a POS 106 or server system 102b, 102c for verification of the user's ability to pay, or displayed on some other device.

### Asset Holding Preference Algorithm

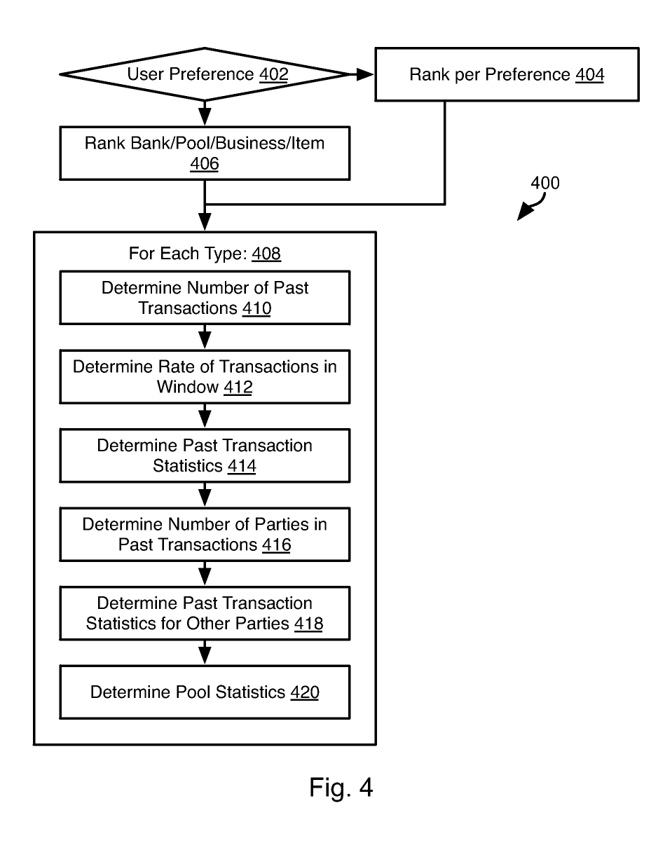

In some embodiments, the asset holding preference algorithm infers the preference of a party to hold a given asset over another, based on the operating rules of each asset held and the preferences of the party holding the assets. For example, the method 400 of FIG. 4 may be used to rank assets held by a given instance party.

For a given instance party, its asset holding preferences and two or more assets held by the instance party, the method 400 may include determining 402 whether an asset holding preference has been set by the user for the two or more assets, or can be inferred through transitivity from the preference set for other assets. If so, then these assets are ranked 404 according to this preference, i.e. the asset having ranked higher by the user or deemed superior by the user to another assets is ranked higher than the other asset.

If no preference can be determined 402 from the user preferences, and the two assets are of different types, then at step 406 bank credit is ranked higher than pool credit, pool credit is ranked higher than business credit, and business credit is ranked higher than item credit.

If the assets are of the same type, the asset preferred is the one with the highest computed preference according to step 408. Specifically, the method 400 may include performing 408 for each type of asset type (business, item, pool) some or all of steps 410-420 with respect to assets of the instance party of the each asset type. The preference computed at step 408 may be represented by a number that serves as a proxy for a monotonically increasing function of both liquidity and time value. For example, other operating rules may apply, such as a first asset expiring earlier than a second asset will have a lower inferred holding preference (e.g. will have a lower rank and will be used to fund transactions before the second asset). In another example, an asset with dormancy fees will have a lower inferred holding preference than an asset with no dormancy fee or a lower dormancy fee. The preference may be computed by determining 410 a number of past transactions for each asset of the asset type. A typical rate at which past transactions in the asset have occurred during a certain time window nay may be determined 412, usually skewed towards the recent (e.g. the last month, last two weeks, or some other interval). Other statistics of the set of past transactions in the asset such as average amount, number of redemptions, and average value of redemptions may be determined 414.

For each asset within a given asset type usage of that asset class by other users may also be used to determine its preference. For example, the number of distinct parties participating in past transactions in the asset may be determined 416 as well as determining other statistics of the set of parties participating in past transactions in the asset, such as average number of redemptions per party and average number of distinct businesses redeemed at per party.

If the asset is a pool credit, the method 400 may include determining 420 pool statistics such as: the number of assets in the pool issued by distinct businesses, the number of consumers in the pool. The pool may be embodied as a electronic representation of a contract between multiple consumers to share assets with each other. Among the assets of the pool the typical rate (e.g. average per unit time) at which cross-redemptions have occurred using the pool receipt over a certain time window, usually skewed towards the recent (e.g. the last month, last week, or some other period).

The actual preference value or rank assigned to an asset may be computed according to a weighted function wherein values according to any of the rules or values described above are weighted and summed to determine a score for the asset.

### Asset Allocation Algorithm

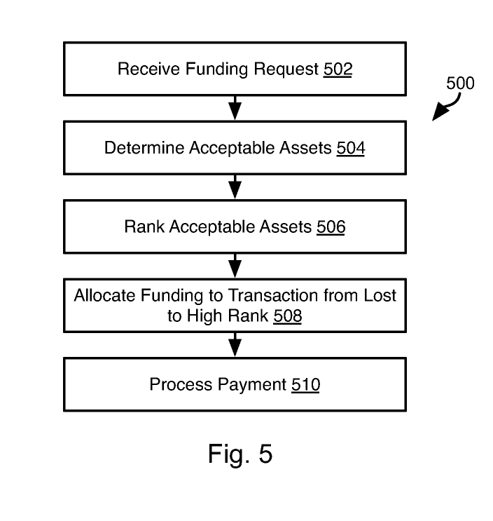

The asset allocation algorithm allocates which amount of which of a buying party's assets to redeem to fund a given transaction at a given business, based on the asset holding preferences of the transacting party. Given the buying party, a selling business party, and a requested amount in the local monetary unit or an arbitrary asset to be transferred from the buying party to the selling party as part of a transaction consisting of arbitrary other transfers, credits may be debited to hind the transaction according to the illustrated method 500 of FIG. 5.

The method 500 may include receiving 502 a funding request from a user, such as from computer device 110, 112 or from a point of sale 106 or ecommerce server 102b, the funding request indicating the requested amount. The funding request may be received in a verifiable fashion, e.g. the funding request may include or follow authentication of one or both of the buying and selling parties prior to performing the steps of the method 500.

The method 500 may further include determining 504 which of the assets (in the same accounting unit as the requested amount) held by the individual are accepted by the business and for what amount. This creates a provisional transfer list. For example, if the selling party is a business then bank credits, credits of that business, and pool credits may be usable to fund the transaction. Where the transaction is to purchase an item, then item credits of the business that are associated with that item may also be determined 504 to be acceptable. Whether an asset is acceptable may be determined according to the attributes of the asset, specifically any limitations on its use as defined by the corresponding credit object model of the asset as described above.

The method 500 may include ranking 506 the buying parties assets, such as according to the method 400. Ranking of the user's assets may be performed prior to receiving 502 a funding request, i.e. periodically according to a schedule or upon the modification of the assets held by the user (e.g. exhaustion or an asset, spending of a portion of an asset, or adding of a new asset).

Funds may then be allocated 508 to the transaction according to the ranking, i.e. some or all of an acceptable asset having the lowest rank (i.e. lowest holding preference) will be applied toward the requested amount, some or all of the an acceptable asset having the next lowest rank will be applied toward the requested amount, and so on until the requested amount has been allocated.

Redemption of the allocated funds to pay for the transaction may then be processed 510 to transfer the allocated funds to the selling party and/or notifying the selling party that payment has been authorized. Processing payment from the allocated assets may proceed according to any electronic payment processing approach known in the art.

### Interfaces

Various interfaces may be provided on a remote computing device 110, 112 for modifying user account preferences of a business or consumer. For example, the business owner user interface may used to create and edit business credits, item credits, bank credits. The pool administrator user interface to create and edit instances of the asset object model

The consumer user interface allows a party holding assets to some or all of view the balance available to them in each asset, to view their purchasing power at each store based on all the assets she or he holds, join one or more pools and deposit store-specific in them, set her or his asset holding preferences, view how its various assets would be allocated to find a particular redemption transaction, and initiate a redemption transaction at a given business. The point-of-sale user interface allows a business employee to view the purchasing power of a party at the business based on all the assets the party holds, and initiate a redemption transaction of the party's asset at the business.

The interfaces described below may be populated by information from the asset database 104a by the server system 102a and displayed on a user device 110, 112. Inputs may be transmitted to the server system 102a which may update the asset database 104a or take other actions described below as being invoked by the database. Alternatively, some or all of the actions taken in response to user inputs may be performed on the user device 110, 112.

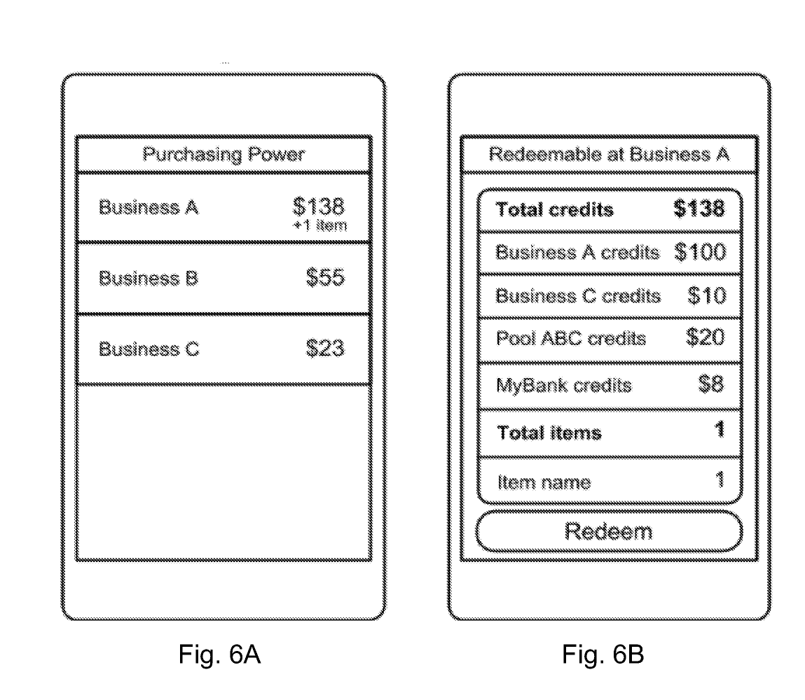

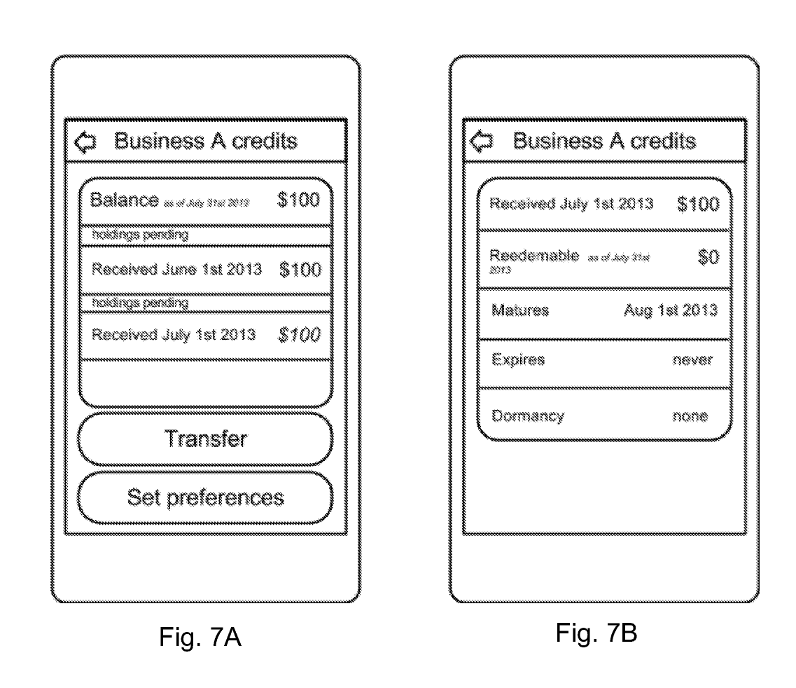

FIGS. 6A and 6B show a diagram of an example of a consumer interface's screen for a user to view his or her purchasing power at all businesses (FIG. 6A), as well as a diagram of the consumer interface's screen for a user to view his or her purchasing power at one business selected from the list of all businesses (FIG. 6B). By selecting one of the businesses in the list of (A) (“Business A,” “Business B,” “Business C,” etc.), the user is transferred to the screen (B) for the selected business. FIG. 6B shows to the user how his or her purchasing power at a business (for instance here Business A) is composed of different assets, some business credits, some pool credits and some bank credits. Item credits are shown in a separate section since they are typically in a non monetary unit and cannot be summed together with monetary assets. By selecting one of the asset listed in (FIG. 6B) the user is transferred to the asset balance details screen in FIGS. 7A and 7B.

The information displayed in the interfaces of FIGS. 6A and 6B may be retrieved from the account information for the user in the asset database 104a. The server system 102 may retrieve and transmit this information for display in the interfaces of FIGS. 6A and 6B on a computing device 110, 112 responsive to a user invoking display of the interfaces 6A and 6B. Likewise, user interactions with the interfaces of FIGS. 6A and 6B on a device 110, 112 may be transmitted to the server system 102a, which then updates the interface as described above with respect to FIGS. 6A and 6B.

FIGS. 7A and 7B show a diagram of an example of a consumer interface's screen for a consumer to view the details of his or her balance in one asset (FIG. 7A) as well as the details of one of his asset holdings (FIG. 7B). In FIG. 7A, the customer's balance in “Business A Credits” is $100 because he or she has two holdings, one of $100 which has matured, and one of $100 that has not matured yet (amount shown in italics). By selecting one of his or her asset holdings, the customer can see the details of the asset holding, in particular if and when the asset matures (“Aug. 1, 2013” in FIG. 7B).

The information displayed in the interfaces of FIGS. 7A and 7B may be retrieved from the account information for the user in the asset database 104a. The server system 102 may retrieve and transmit this information for display in the interfaces of FIGS. 7A and 7B on a computing device 110, 112 responsive to a user invoking display of the interfaces 7A and 7B. Likewise, user interactions with the interfaces of FIGS. 7A and 7B on a device 110, 112 may be transmitted to the server system 102a, which then updates the interface as described above with respect to FIGS. 7A and 7B.

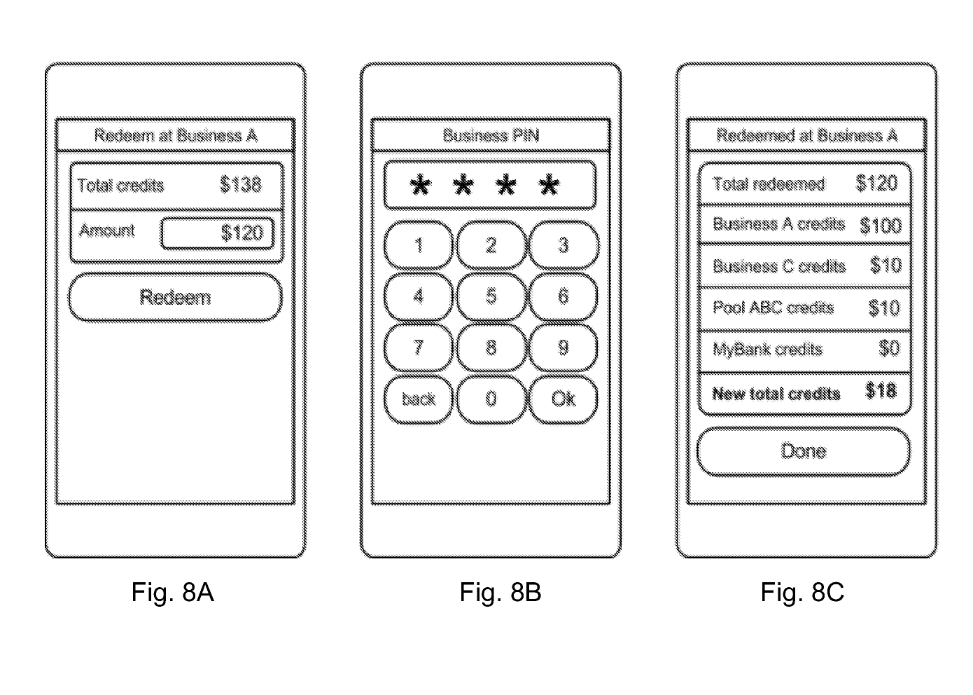

FIGS. 8A to 8C show a diagram of an example of a consumer interface's screen for a user to initiate a credits redemption at a business (FIG. 8A) as well as an optional authorization screen for the business' employee (FIG. 8B) and finally a redemption confirmation screen for the user (FIG. 8C). When a user wants to redeem credits at a business he can enter on his device an amount inferior or equal to his or her purchasing power at the business, for instance $120 in FIG. 8A. Then, typically the customer passes his or her device to the business employee to confirm the transaction by letting the employee enter an employee-specific 4-digit PIN (FIG. 813) and finally the employee sees the transaction confirmation and passes the device back to the customer (FIG. 8C). As shown in FIG. 8C the confirmation details how the redemption has affected the purchasing power of the customer at this business by showing how the transaction has affected the redeemable balance of each asset the customer hold. In FIG. 8C for example, the asset “Business A credits” was redeemed first for $100 (totally), then the asset “Business C credits” as redeemed for $10, then the asset “Pool ABC credits” by redeemed for $10. The other assets were not redeemed. This is because “Business A credits” is less preferred than “Business A credits” which is less preferred than “Pool ABC credits” which is less preferred than “MyBank credits”.

The information displayed in the interfaces of FIGS. 8A to 8C may be retrieved from the account information for the user in the asset database 104a. The server system 102 may retrieve and transmit this information for display in the interfaces of FIGS. 8A to 8C on a computing device 110, 112 responsive to a user invoking display of the interfaces 8A to 8C. Likewise, user interactions with the interfaces of FIGS. 8A to 8C on a device 110, 112 may be transmitted to the server system 102a, which then updates the interface as described above with respect to FIGS. 8A to 8C.

FIGS. 9A to 9C show one example of how a customer can initiate a transfer between assets (FIG. 9A) and how such a transfer impacts purchasing power at a business (FIG. 913) and at another (FIG. 9C). FIG. 9A shows an example of a $10 transfer initiated between “Business A credits” to “Pool ABC credits”. This transfer is possible because “Pool ABC credits” operating rules accept “Business A credits” from the customer. After the transfer, if the customer looks at the customer's purchasing power at Business A (FIG. 9B), the customer has the same purchasing power ($138) but different balances for “Business A credits” or “Pool ABC” credits. After the transfer, if the customer looks at the customer's purchasing power at Business C (FIG. 9C C) the customer can see that that the customer's purchasing power has increased, in the example illustrated, by $20 through the contribution of $30 to “Pool ABC credits”. The purchasing power may have increased by $20 rather than $30 because it may be that Pool ABC contains only $20 “Business C Credits,” so even though the customer has $30 “Pool ABC credits” she can only withdraw $20 “Business C Credits” from the pool for purchases at Business C.

The information displayed in the interfaces of FIGS. 9A to 9C may be retrieved from the account information for the user in the asset database 104a. The server system 102 may retrieve and transmit this information for display in the interfaces of FIGS. 9A to 9C on a computing device 110, 112 responsive to a user invoking display of the interfaces 9A to 9C. Likewise, user interactions with the interfaces of FIGS. 9A to 9C on a device 110, 112 may be transmitted to the server system 102a, which then updates the interface as described above with respect to FIGS. 9A to 9C,

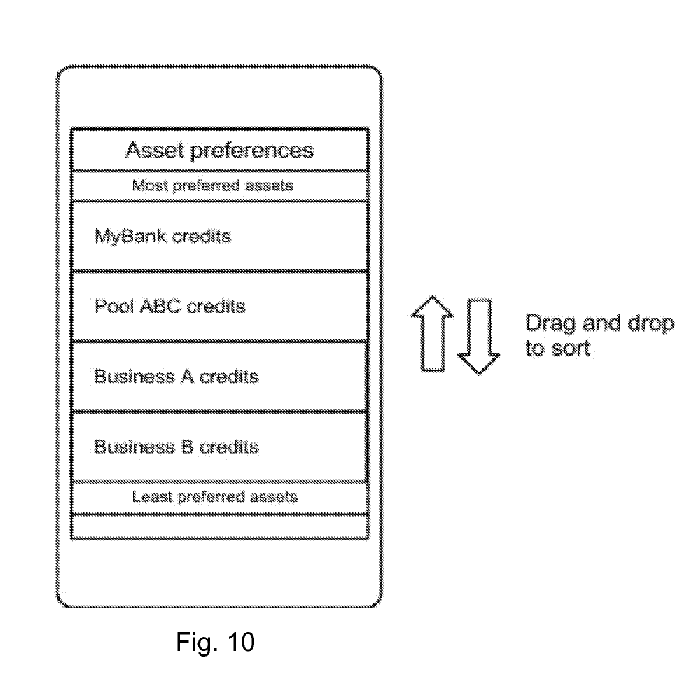

FIG. 10 shows one example of a diagram of a screen of the consumer user interface that the customer can use to change the computed asset holding preference of various assets he or she holds. The preference can be assigned from most preferred to least preferred by respectively dragging up and down the assets in the list. Other interface elements may also be used to adjust the ranking of assets.

The information displayed in the interface of FIG. 10 may be retrieved from the account information for the user in the asset database 104a. The server system 102 may retrieve and transmit this information for display in the interface of FIG. 10 on a computing device 110, 112 responsive to a user invoking display of the interface of FIG. 10. Likewise, user interactions with the interface of FIG. 10 on a device 110, 112 may be transmitted to the server system 102a, which then updates the interface as described above with respect to FIG. 10. In particular, the reordering of assets received in the interface of FIG. 10 maybe stored in the account of a user in the asset database 104a.

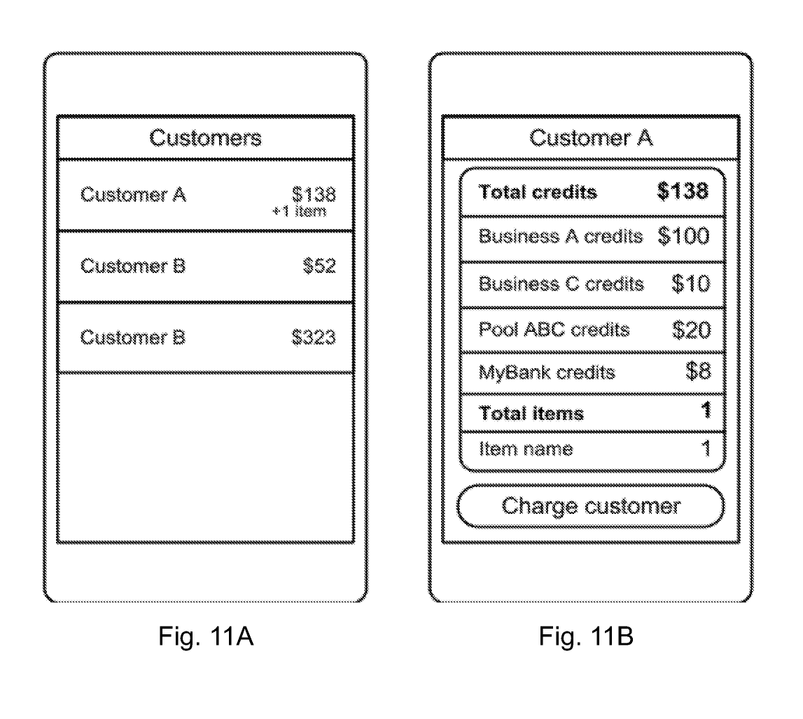

FIGS. 11A and 11B show examples of two screens of the employee user interface, such as might be displayed on a POS 106 or some other computing device used by an employee at a physical retail location. FIG. 11A shows the purchasing power of all customers who can redeem at business A given the assets they hold, whether they are credits issued by business A, or pool credits that can be exchanged for credits issued by business A, or bank credits. The employee can also see in FIG. 11A whether a customer has item-specific credits (“+1 item”). The employee can select a customer to invoke display of the customer's purchasing power details as shown in FIG. 11B. In FIG. 11B, the employee can see a customer's purchasing power details as a list of assets that can be redeemed at the business, such as business-specific credits issued by business A, business-specific credits not issued but accepted by business A, pool credits that can be exchanged for credits issued or accepted by business A, and bank credits.

The information displayed in the interfaces of FIGS. 11A and 11B may be retrieved from the account information for the user in the asset database 104a. The server system 102 may retrieve and transmit this information for display in the interfaces of FIGS. 11A and 11B on a computing device or POS 106 of an employee responsive to a user invoking display of the interfaces 11A and 11B. Likewise, user interactions with the interfaces of FIGS. 11A and 11B on a POS 106 or other computing, device may be transmitted to the server system 102a, which then updates the interface as described above with respect to FIGS. 11A and 11B.

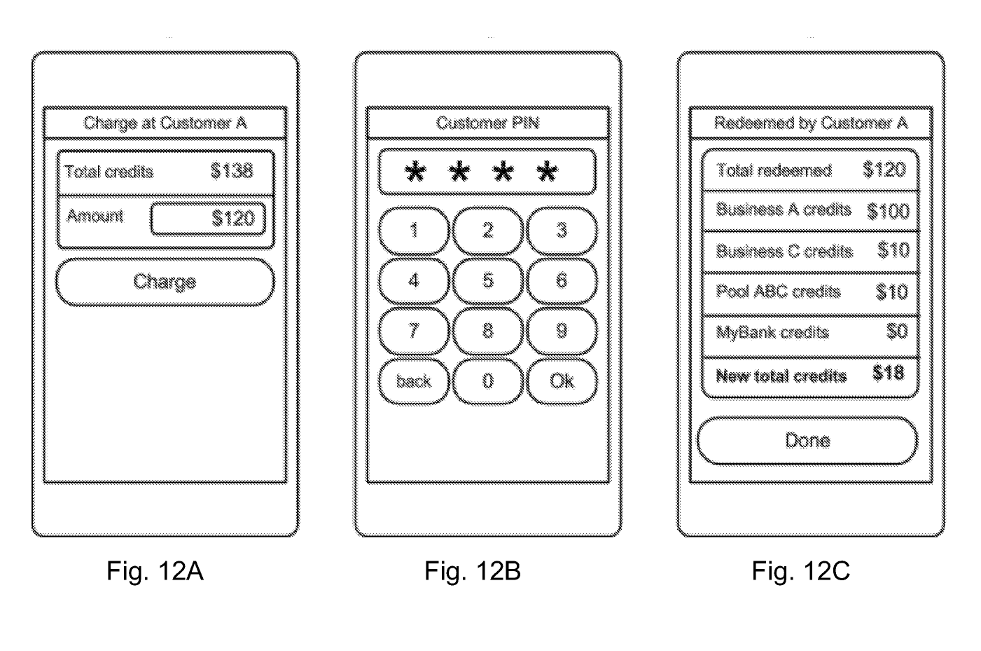

FIGS. 12A to 12C show examples of the employee user interface's screen for an employee to initiate a credit redemption from a customer (FIG. 12A) as well as an optional authorization screen for the customer (FIG. 12B) and finally a redemption confirmation screen for the employee (FIG. 12C). When a customer wants to redeem credits at a business, the business employee can enter on his device an amount inferior or equal to the customer's purchasing power at the business for instance $120 on diagram (FIG. 12A). Then, display of the interface of FIG. 12B is invoked automatically or in response to an instruction received on the interface (e.g. tapping “charge”). The employee may pass his or her computing device to the customer to confirm the transaction by letting the customer enter an customer-specific 4-digit PIN (FIG. 12B) and, in response to receiving this PIN, the interface of FIG. 1.2C is displayed and the employee sees the transaction confirmation. The pin input as shown at FIG. 12B may be verified with the server system 102a prior to presenting the transaction confirmation (FIG. 12C).

As shown in FIG. 12C the confirmation details how the redemption has affected the purchasing power of the customer at this business by showing how the transaction has affected the redeemable balance of each asset the customer hold. In FIG. 12C, for example, the asset “Business A credits” was redeemed first for $100 (totally), then the asset “Business C credits” was redeemed for $10, then the asset “Pool ABC credits” was redeemed for $10. The other assets were not redeemed. This is because “Business A credits” is less preferred than “Business C Credits” which is less preferred than “Pool ABC credits” which is less preferred than “MyBank credits”. This ordered depleting of the assets may be performed according to the method 500 of FIG. 5.

The information displayed in the interfaces of FIGS. 12A to 12C may be retrieved from the account information for the user in the asset database 104a. The server system 102 may retrieve and transmit this information for display in the interfaces of FIGS. 12A to 12C on a computing device or POS 106 of an employee responsive to a user invoking display of the interfaces 12A to 12C. Likewise, user interactions with the interfaces of FIGS. 12A to 12C on a POS 106 or other computing device may be transmitted to the server system 102a, which then updates the interface as described above with respect to FIGS. 12A to 12C.

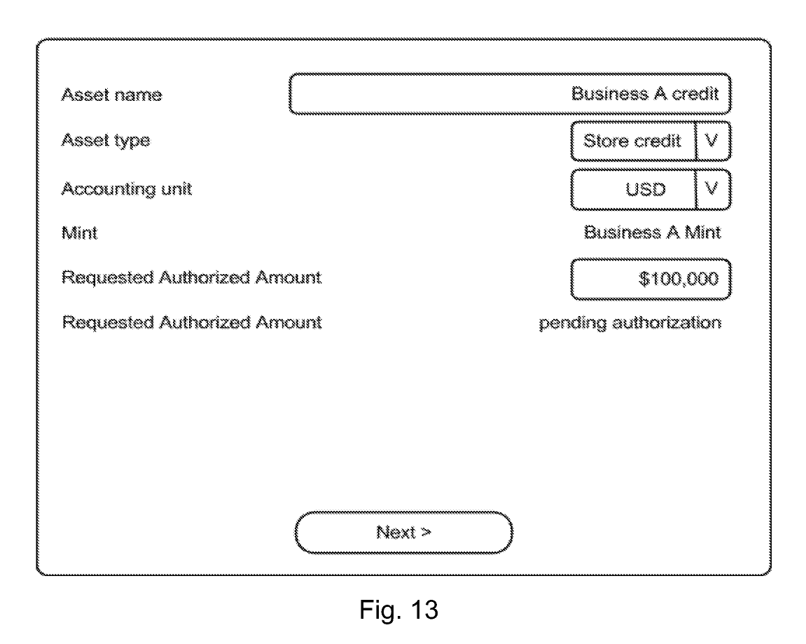

FIG. 13 shows one example of a diagram of the asset editor screen in the business owner user interface. The business owner can create and configure a new asset by specifying an asset name, type, accounting unit, and a request authorized amount. Data entered into the interface of FIG. 13 may be transmitted to the server system 102a and stored by the server system 102a in account data for the business owner in the database 104a for use in defining assets to be assigned to customer,

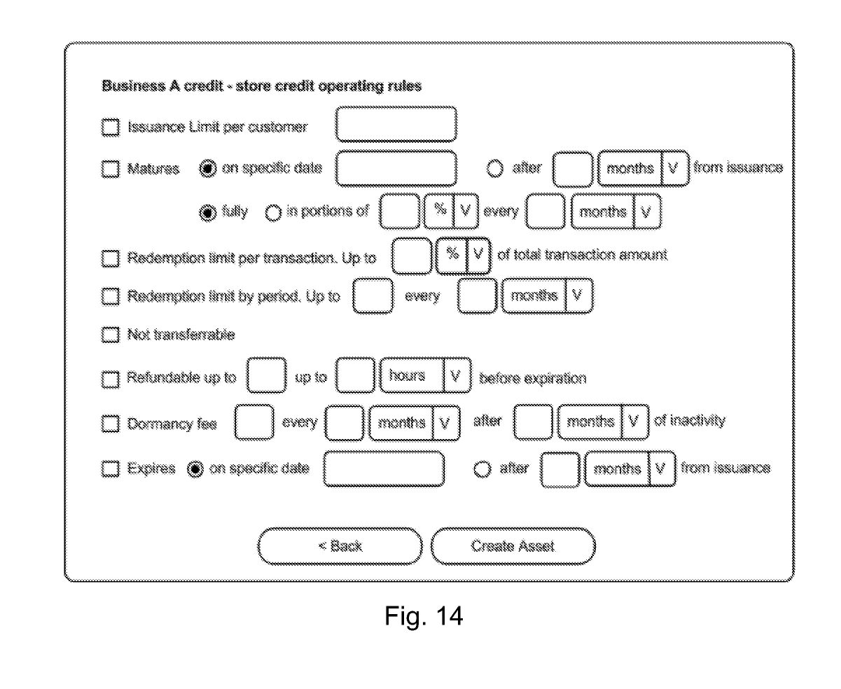

FIG. 14 shows one example of a diagram of the store credit asset editor screen in the business owner user interface. This is the screen used by the business owner if she or he chose to create an asset of type “store credit”. The business owner can use the screen to configure all the operating rules of the asset such as issuance limits per customers, maturity, redemption limits, refundability, transferability, dormancy, expiration. Data entered into the interface of FIG. 14 may be transmitted to the server system 102a and stored by the server system 102a in account data for the business owner in the database 104a for use in defining assets to be assigned to customer. For example, in response to an instruction to create an asset for a specific amount received from the business, rules defined according to the parameters of FIG. 14 may be applied by the server system 102a and used to define the asset and limit the user of the asset to fund transactions,

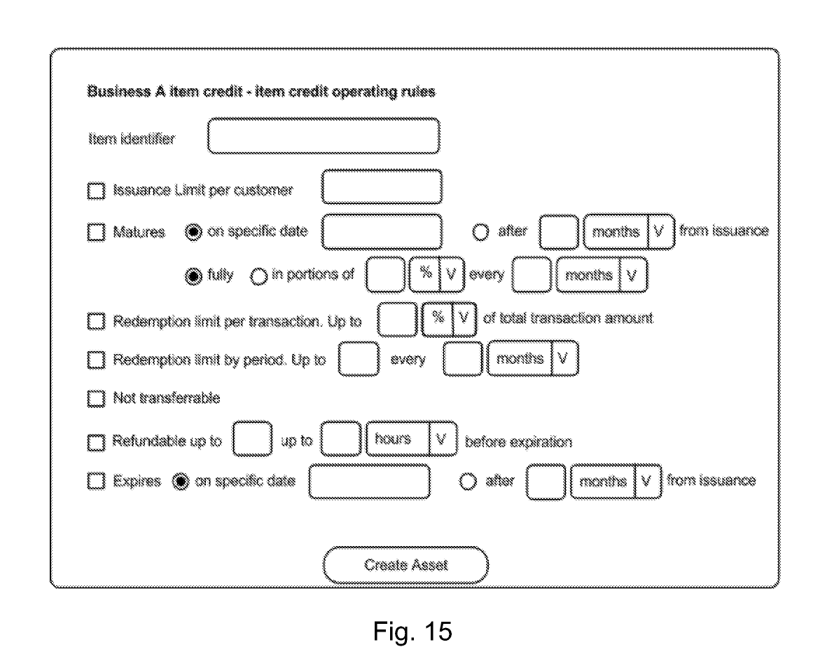

FIG. 15 shows one example of a diagram of the item credit asset editor screen in the business owner user interface. This is the screen used by the business owner if she or he chose to create an asset of type “item credit”. The interface is similar to the screen for creating/editing a “store credit”. The main difference is the required “Product Identifier” field. Assets may be instantiated by the server system 102a in response to receiving parameters specified in the interface of FIG. 15 on a user device 110, 112 and transmitted to the server system 102a. In particular, an asset generated according to the parameters of FIG. 15 is an item credit and is limited to redemption for the item identified in the “item identifier” field at the issuing business (Business A).

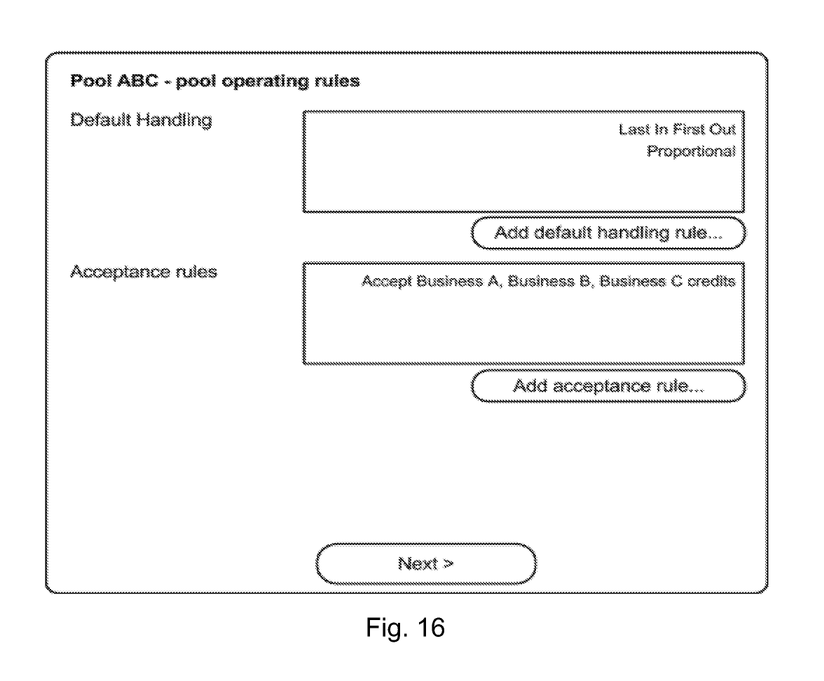

FIG. 16 shows one example of a diagram of the pool editor in the pool administrator user interface. This screen is used by a pool administrator to create and edit an asset of type “poor”. The interface may require a user to provide a list of acceptance rules and an ordered list of defaulting rules (e.g., default is “proportional”). In response to parameters received in the interface of FIG. 16, the rules may be transmitted to the server system 102a and stored by the server system 102a in an account of the creating user in asset database 104. Subsequent pool assets defined by that user may be instantiated by the server system 102a and processed in accordance with the rules received.

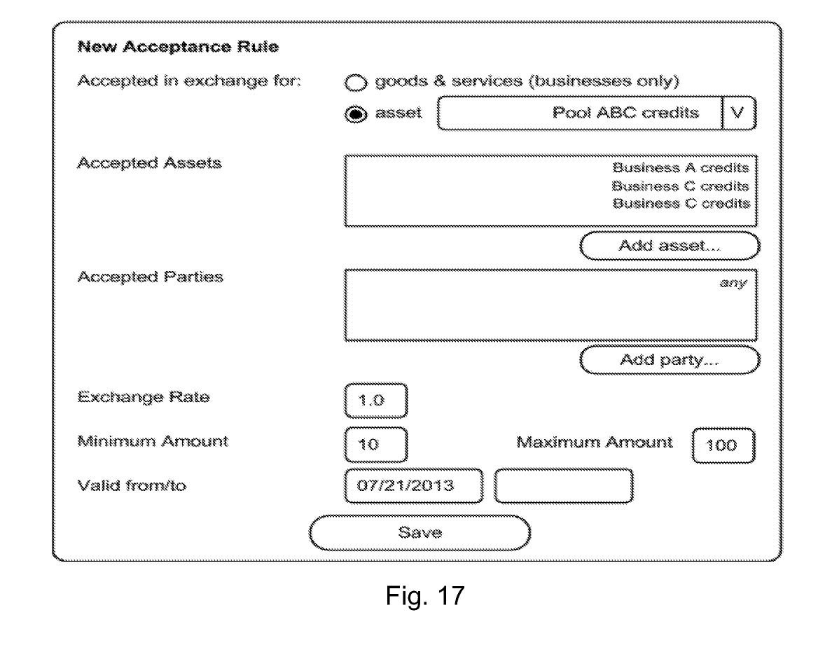

FIG. 17 shows one example of a diagram of the acceptance rules editor in the business owner user interface, pool administrator interface and in the consumer interface. This screen is used by the business owner or consumer or pool administrator to configure which assets the party accepts in exchange for which assets (e.g. Business A, B, and C credits). In response to parameters received in the interface of FIG. 17, the rules may be transmitted to the server system 102a and stored by the server system 102a in an account of the creating user in asset database 104. Subsequent pool assets defined by that user may be instantiated by the server system 102a and processed in accordance with the rules received. As is apparent in FIG. 17 rules may specify the entities from which credits may be added to the pool and parameters governing what assets may be added to the pool and in what amounts.

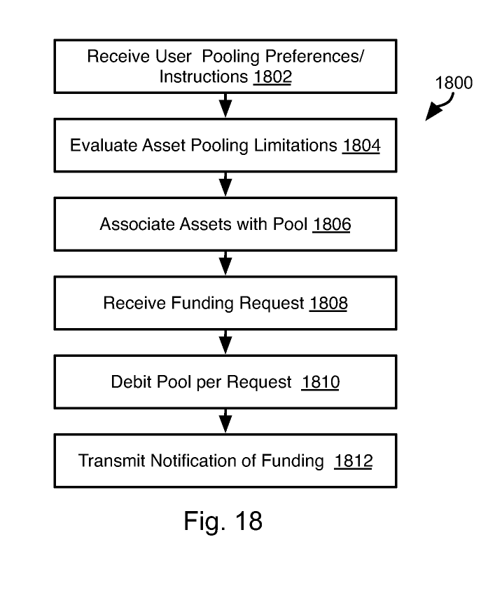

FIG. 18 illustrates a method 1800 for processing transactions using a pool asset of a buying party with respect to a product sold by a selling party. In particular, the method 1800 may be executed with respect to rules received according to one or both of the interfaces of FIGS. 16 and 17 or some other rules.

The method 1800 may include receiving 1802 user pooling preferences or instructions. For example, step 1802 may include receiving an instruction to add some or all of an asset to a selected pool or receiving a rule specifying that, for example, the largest amount transferable to a pool of an asset shall be added to the pool as soon as permitted by the asset (e.g. upon full or partial maturity of the asset).

The method 1500 may further include evaluating 1802 pooling limitations. For example, as shown in FIGS. 16 and 17 the issuer of an asset may specify assets of what businesses may be added to a pool or pooled together, an exchange rate, minimum amount, maximum amount, or other limitations.

At step 1804 some or all of the amounts of the assets specified according to the received rule or instruction at step 1804 are added to the pool insofar as they are compliant with the rules evaluated at step 1802. For example, where the amounts specified by the user exceed a maximum amount defined for pooling of an asset, the maximum amount may be added. Where the amount specified by the user is below a minimum amount defined for an asset, the request to add the amount to the pool maybe ignored.

The method 1800 may further include receiving 1808 funding requests from a user or business, debiting 1810 the pool to fund the request, and transmitting 1812 notification of funding to the user or business. In particular, steps 1808-1812 may be performed as described above with respect to FIG. 5. Steps 1808-1812 may be performed with respect to funds in the pool according to any method for debiting an account of a user to fund a transaction whether at an in-store POS or an online POS for an ecommerce transaction.

### Loyalty

Credits issued and processed as disclosed herein may be generated as part of a system in which business credits are issued as rewards for purchases and automatically placed into a pool when issued by a business that is a member of a group such as a neighborhood merchant association, industry association, local chapter of an industry association, or chamber of commerce, thereby providing cross-redemption options for holders of the pool credits.

### Crowdfunding

Credits issued and processed as disclosed herein may be generated as part of a system in which customers exchange money in their bank accounts (bank credits) for the same amount in business-specific credits and get additional business-specific credits that are automatically placed into a pool when issued by a business that is a member of a group such as a neighborhood merchant association, industry association, local chapter of an industry association, or chamber of commerce, thereby providing cross-redemption options for holders of the pool credits.

### Employee Benefits

Credits issued and processed as disclosed herein may be generated as part of a system in which an employer exchanges money in its bank account (bank credits) for the same amount in business-specific credits from several different businesses, then places these business-specific credits into an employee pool, and then distributes the pool credits to its employees, thereby providing its employees with a benefit at the businesses.

### Barter

Credits issued and processed as disclosed herein may be generated as part of a system in which a business issues to a supplier business-specific credits in payment for goods received and/or services performed, then the supplier places these business-specific credits into the pool of its choice, thereby allowing the supplier to redeem these credits at businesses other than the one that it received them from.

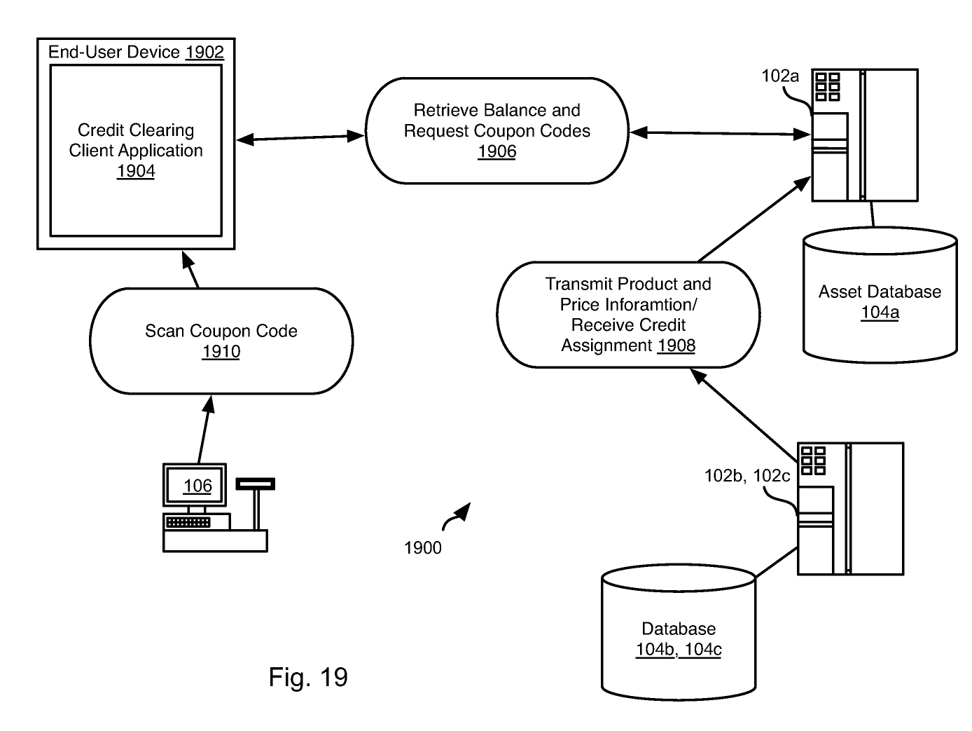

FIG. 19 is an illustration of a network environment 1900 that may be used to perform redemption of business credits. The illustrated network environment 1900 may be implemented by the same network environment 100 of FIG. 1. The network environment 1900 may include an end-user computing device 1902 hosting a credit clearing client application 1904. The end-user device 1902 may be embodied as a computing device 110, 112.

The end-user device 1902, specifically the application 1904, may interact with the server system 102a to implement methods as described herein. For example, the application 1904 may retrieve 1906 from the server system 102a balances for one or more brand-specific credits and request codes, e.g. coupon codes, for redeeming brand-specific accounts.

The accounts of multiple users and the brand-specific credits assigned to each user may be stored in the asset database 104a. The brand-specific credits may be processed according to any of the methods disclosed herein, i.e. the brand-specific credits may be an instance of a business credit object model or any of the asset object models described herein and may be processed or have attributes according to any of the methods described herein.

The server system 102a may facilitate navigation of a product database of one or more retailers. Accordingly, a server system 102b, 102c of a retailer may transmit 1908 product information to the server system 102a for viewing in the application 1904. Alternatively, such information may be transmitted directly to the application 1904 by the server system 102b, 102c. The server systems 102b, 102c may further transmit credits assigned to users to the server system 102a for storage in the accounts of users. For example, a retailer may assign a credit for Brand A to customer A. The brand-specific credit may be specific to the retailer's brand, i.e. redeemable for products sold by the retailer. Alternatively, the brand-specific credit may be for a brand of products that the retailer may or may not carry. Assignment of brand-specific credits may also be received by the server system 102a from an entity other than a retailer, such as a manufacture of the brand corresponding to the brand-specific credits or any other entity. An assignment of a brand-specific credit may indicate the brand and an amount. An assignment of a brand-specific credit may include some or all of the limitations or parameters governing the processing of an asset of any of the asset types described herein.

A coupon code transmitted to the application 1904 may be displayed on a display device of the end-user device 1902 or printed onto paper or any other physical media. The coupon code may indicate an amount authorized by the coupon and may indicate other information such as a brand or product that can be purchased using the amount authorized. A PUS device 106 may scan 1910 the code in order to receive information encoded in the coupon and apply funds authorized by the coupon toward a transaction conducted on the POS 106.

The methods described herein may use the illustrated environment 1900 to enable an end-user holding a balance of brand-specific credits to pay at a general retail store distributing products produced by the brand for products of that brand only.

A balance of brand-specific credits, such as a brand-issued gift card is generally only redeemable at a location of the brand who issued the credits. In some cases, the brand-specific credits can be redeemed at a business other than the brand who issued the credits, but the process requires exchanging the brand-specific credits for credits that the other business accepts, typically bank-issued credits, and does not provide a way to constrain the redemption of brand-specific products to products of that brand only distributed at the other business. Brands also typically issue vendor coupons, which can be redeemed for brand-only products at a general retail store, but these coupons are for a specific amount (e.g. $1 off) or specific portion of the product price (e.g. 10% off). These coupons cannot be used for redeeming an arbitrary portion of a brand-specific credits balance issued to a brand's customer.

The systems and methods disclosed herein provide the ability for an end-user holding a balance of brand-specific credits to redeem these credits for products produced of that brand only at a general retail store who distributes products of that brand. An end user may invoke redemption of brand-specific credits on an application 1904 on the end-user device 1902 part or all of the brand-specific credits balance held by the end-user for one or more special free item coupons for each product of that brand that the end-user wants to pay with brand-specific credits. Each free item coupon obtained is scanned by the retail store cashier at checkout and the POS 106 applies a credit to the total corresponding to the price of the product at the retail store. The redemption further includes deducting by the server system 102a from the end-user brand-specific credits balance the price at the retail store of each product purchased by the end-user. This ensures that the end-user cannot redeem more products of the brand at the retail store than allowed by his/her bran-specific credits balance. Each free item coupon is product-specific, ensuring that the brand-specific credits can only be used for products of that brand at the retail store.

A free item coupon may be embodied as a UPC A, or some other code, that is generated from the product UPC by taking the 5-digit manufacturer ID and 3-digit family code from the UPC of the product and concatenating them into a new UPC as follows: “5” (coupon), 5-digit manufacturer ID, 3-digit family code, “01” value code (free item), and the standard computed check digit. Most point-of-sale in the world can interpret such a UPC coupon code and will automatically apply a credit to the total due corresponding to the full price of the item, as long as a product with a matching 5-digit manufacturer ID and 3-digit family code has been scanned by the point-of-sale system.

In some embodiments, the application 1904 on the end-user device has access to the price at the retail store of all products of the brand distributed by the retail store, but the some embodiments allow for price incorrectness by involving the cashier at the retail store in the redemption process. For example, before obtaining free item coupon codes, the end-user is prompted by the application 1904 on the end-user device to ask the cashier to verify the price of each product paid with brand-specific credits. If there is a price difference, the cashier asks the end-user to correct the price to match the price provided by the POS system. This process ensures that the correct amount of credits is debited from the end-user brand-specific balance. In some embodiments, coupons may be designed to work with any retail point-of-sale system, which supports UPC coupon codes. The system may function without the cashier having to touch the end-user device at any point in the redemption process,

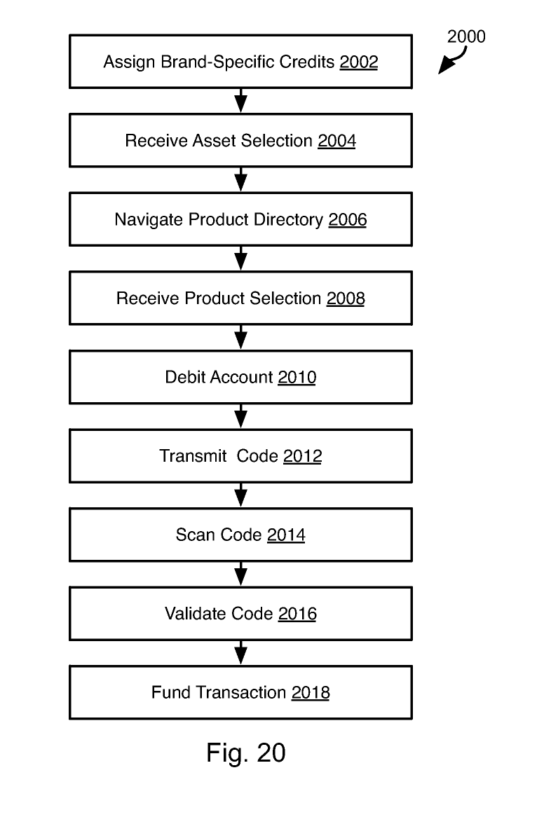

FIG. 20 illustrates an example method 2000 that may be performed using the illustrated environment 1900. The method 2000 may include assigning 2002 brand-specific credits to a user. Assigning 2002 brand-specific credits may include notifying the server system 102a of assignment of the brand-specific credit, the notification including the brand to which the credit is limited and an amount of the credit. The notification may include some or all of the parameters of other assets types described herein. The notification may be transmitted to the server system 102a by a retailer server system 102b, 102c, a server system of a manufacturer, or some other entity.

The end-user device 1902 may be a mobile device with mobile Internet access and geolocation capability. The end-user application software 1904 retrieves brand-specific credit balances from the server system 102a and displays them to the user on the end-user device 1902. A selection of one of these assets may be received 2004. The server system 102a retrieves product information from the brands product information database (e.g. a database 104b, 104c, or some other database), in particular their price at the retail stores where the brand's products are distributed. This information is presented on the end-user device 1902 in response to navigation 2006 of the product directory by the user to find a desired product. A selection of a product may then be received 2010 on the end-user device 1902 and redemption requested. Notification of the selection and desire to redeem some or all of the selected asset may be transmitted to the server system 102a.

Upon receiving a request for redemption from the application 1904 responsive to a user instruction, the server system 102a uses the price information of each product paid with brand-specific credits to debit 2010 the end-user brand-specific credits balance(s) of the corresponding amount and transmits 2012 a free item coupons to the end-user application 1904 for display on the display device of the end-user device 1902. This code may then be scanned 2014 by a POS 106. The POS may validate 2016 the code, either by evaluating the content of the code itself to verify that it is authentic or verifying with the server system 102a that the code, or some data extracted therefrom, is valid and authorizes application of the purchase price toward the purchase of the selected product. The POS 106 may then use the coupon code to fund 2018 the transaction. Funding 2018 the transaction may, for example, include processing the electronic transfer of ft ds from an account of a payee to the account of the retailer operating the POs 106. The payee may be the operator of the server system 102a or the assigner of the brand-specific credit being redeemed.

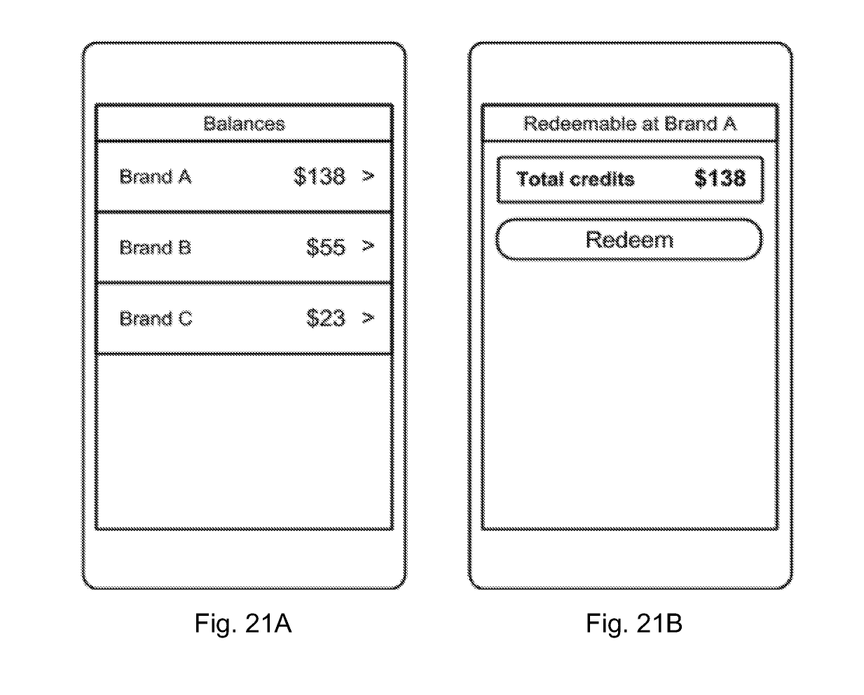

FIGS. 21A and 21B show how the application 1904 on the end-user device shows the credit balance at various brands. To initiate the process of redeeming part or all of brand-specific credits balance, the end-user selects the brand (e.g. “Brand” of FIG. 21A). In response to this selection, the interface of FIG. 21B may be displayed. Redeeming the credits for the selected brand may be initiated by the user tapping “Redeem” in the interface of FIG. 21B. The selection of a brand-specific credit and the instruction to redeem may be transmitted to the server system 102a. Likewise, the information displayed in FIG. 21A may be retrieved from the asset database 104a by way of the server system 102a.

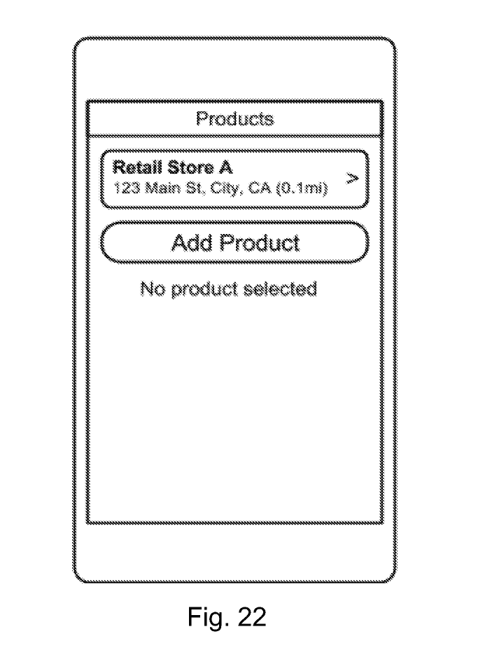

FIG. 22 shows how the redemption location is confirmed. The location of the end-user device is obtained by the application 1904 (e.g. using a geo-locating service of the end-user device 1902) and transmitted to the server system 102a where it is matched against a list of retail stores where the brand-specific credits are accepted. The closest accepting retail store may be selected and assumed to be where the end-user is shopping. The location of this retail store may be returned to the application 1904 and displayed to the use as shown in the interface of FIG. 22. If the retail store returned by the server system 102a is not where the end-user is shopping the end-user can tap the displayed location and select another from a list (not shown in figure). The redemption location confirmation screen also provides a way for the end-user to list the products that the end-user wants to pay with brand-specific credits. At first, there is no product listed. The end-user can tap “Add product” to start adding one or more products to the list, i.e. invoke navigation of a product database for the selected retail store. In some embodiments, the payment for products from distinct brands may be permitted by the server system 102a only if the retail store is registered on the server system 102a to accept the credits issued by each brand.

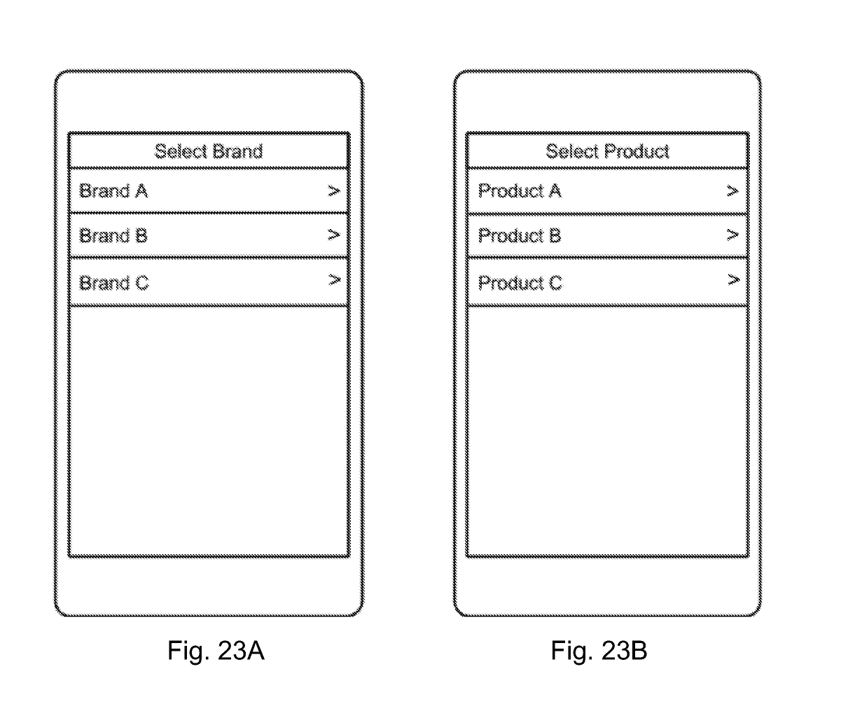

FIGS. 23A and 23B show part of the product selection process. Any interface for navigating a product hierarchy and selecting a desired product may be used to receive a user's selection of a product. For example, in the interface of FIG. 23A, the end-user first selects a brand from the list of brands whose products are distributed at the selected retail store. As shown in FIG. 2313, the end-user then is presented with one or more of a brand's products that are distributed at the selected retail store. The user may then select one of these products by tapping on one of them.

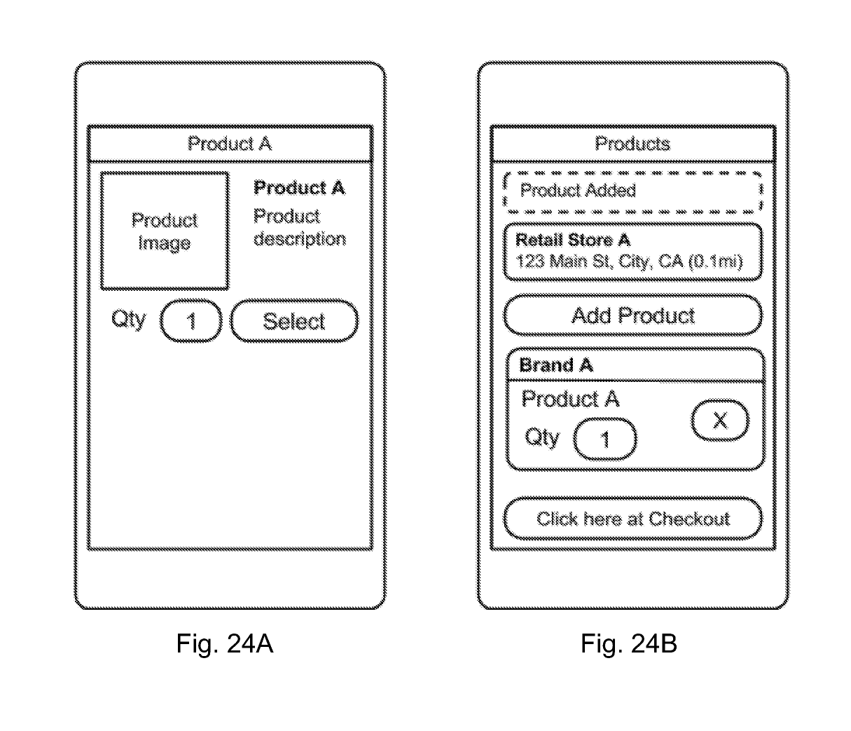

FIGS. 24A and 24B show the details of a product. The interfaces of FIGS. 24A and 24B may be displayed in response to receiving a selection of a product in the interface of FIG. 23B. The information displayed in the interfaces of FIGS. 24A and 24B may be retrieved by the application 1904 from the server system 102a in response to the user selection. As noted above, the server system 102a may obtain the information from a database 104b, 104c of some other entity and return the information to the application 1904. The application 1904 displays such information as a product image, description, and size to the user to reduce the risk of the end-user not selecting the right product. The end-user can enter the quantity of the selected product that the end-user wants to buy with brand-specific credits, and then tap “select”. If the balance of brand-specific credits is insufficient, then the “select” area may be disabled. If the balance of brand-specific credits is sufficient to cover the total (product price multiplied by quantity purchased) of the product selected, the product is added to the list of products to be paid with brand-specific credits and the interface of FIG. 24B is displayed. At the same time, a button “Click here when at checkout” may be displayed.

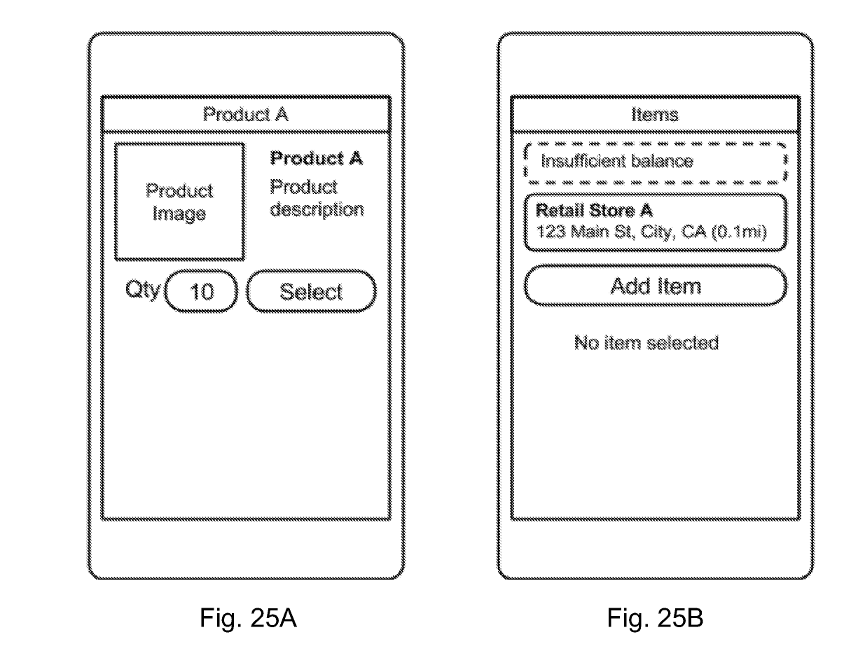

FIGS. 25A and 25B shows a possible case of the end-user not having enough brand-specific credits to buy the quantity selected. In this example, the end-user selects 10 items from brand A, but if the product is priced $14 at the retail store location selected, the end-user balance may not be sufficient and in this case, the product and quantity cannot be added to the list to be paid with brand-specific products. As shown in FIG. 2513, upon tapping “select” in the interface of FIG. 25A, the interface of FIG. 25B may be displayed. By tapping “add item,” the user may again navigate the product directory and attempt to find a product or quantity thereof that can be funded using the brand-specific credits.

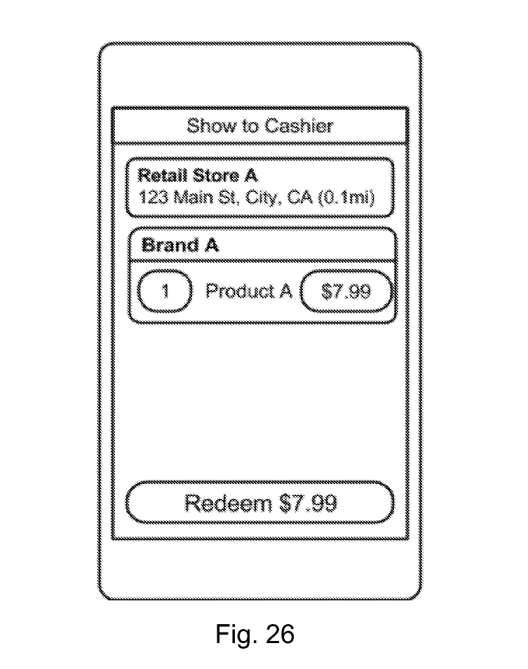

FIG. 26 shows the screen displayed when the user taps “Click here when at checkout” in the interface of FIG. 25B. In some embodiments, the end-user will tell the cashier at checkout that he/she intends to pay with his/her brand-specific credits balance. This cashier is trained to request the end-user to show his device screen showing the list of products selected. On this screen, the price of the products and quantity are shown for the cashier to verify. If there is any discrepancy, the cashier is trained to ask the end-user to make corrections. Corrections are made by the end-user by tapping the quantity or price and changing it using a numeric pad. Once the cashier has verified prices, the cashier asks the end-user to tap redeem. At this point the end-user balance is debited by the corresponding amount and free item coupon codes are generated,

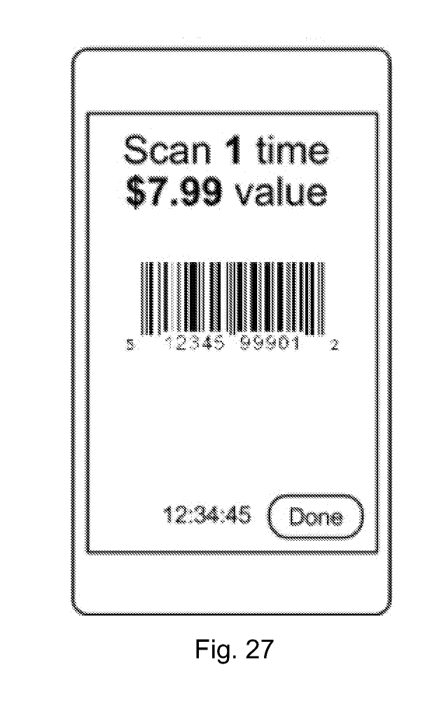

FIG. 27 shows an interface with a UPC free item coupon code. The optical code of FIG. 27 may be Obtained by the application 1904 transmitting the user's selection of a product and quantity to the server system 102a, which then transmits the illustrated code. Although a barcode is shown, other optical codes may be used such as OR (quick response) or other codes. The coupon code corresponds to the product that vas selected earlier (e.g., same 5-digit manufacturer ID and same 3-digit family code, plus a “01” value code indicating a free product). The coupon code may encode an identifier of the product in some other manner. The cashier is trained to scan these barcodes from the end-user device. By standard, each code may be automatically interpreted by the point-of-sale system in such a way that a credit corresponding to the product price will be applied to the total due. In the example of FIG. 27 the point-of-sale system will automatically apply a credit corresponding to the price of the product in the point-of-sales if a matching product (manufacturer ID 12345, family code 999) has been scanned. This is why the step where the cashier verifies the price (FIG. 26) is performed in some embodiments: the price in the end-user application software must exactly match the price in the point-of-sale system in such embodiments.

The systems and methods disclosed herein advantageously provide for redeeming a balance of brand-specific credits that have been issued to an end-user as a reward for past purchases of that brand, to be redeemed at one or more retail stores for products of that brand only. The systems and methods disclosed herein advantageously enable redeeming a balance of brand-specific credits that have been issued to an end-user to incentivize the purchase of any or specific products of the brand at one or more retails stores.

The systems and methods disclosed herein advantageously enable redeeming a balance of brand-specific credits that have been issued to an end-user in exchange for cash upfront, typically in excess of the cash amount received (say $110 brand-specific credits for $100 cash), to be redeemed for products of that brand only at one or more retail stores.

The systems and methods disclosed herein advantageously enable redeeming of a balance of brand or product-specific credits that have been issued to an employee by its employer, or to a public welfare recipient by a public organization to redeem for any or specific products of that brand at one or more retail stores.

The systems and methods disclosed herein advantageously enable redeeming of a balance of product-specific or product family-specific credits issued by a brand to be redeemed for one or more specific products, or products from one or more families of products of that brand at one or more retail stores,

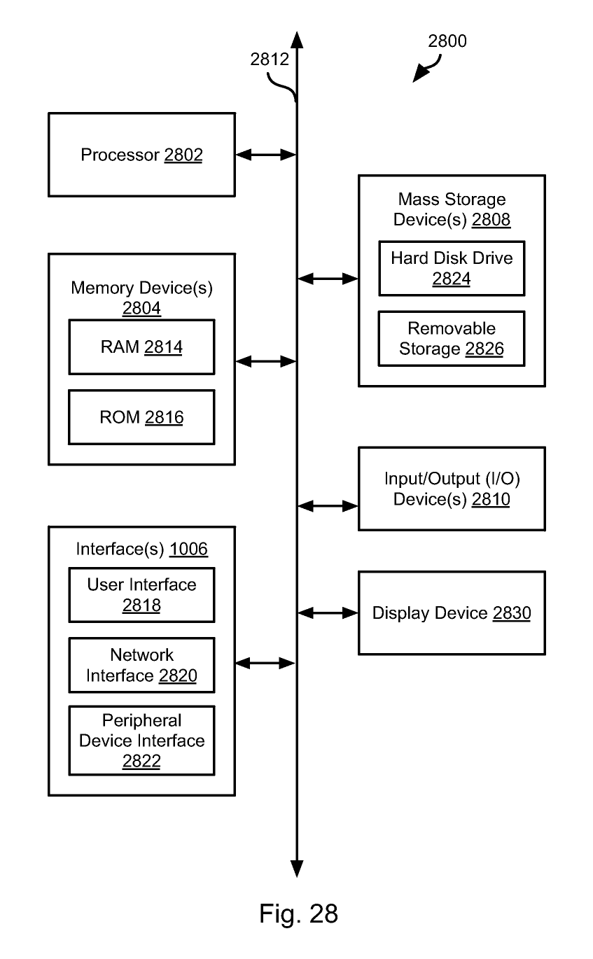

FIG. 28 is a block diagram illustrating an example computing device 2600. Computing device 2800 may be used to perform various procedures, such as those discussed herein. Computing device 2800 can function as a server, a client, or any other computing device or computing entity. For example, the server systems 102a-102d, computing devices 110, 112, and end-user device 1902 may be embodied as one or more computing devices Computing device can perform various monitoring functions as discussed herein, and can execute one or more application programs, such as the application programs described herein. Computing device 2800 can be any of a wide variety of computing devices, such as a desktop computer, a notebook computer, a server computer, a handheld computer, tablet computer and the like.

Computing device 2800 includes one or more processor(s) 2802, one or more memory device(s) 2804, one or more interface(s) 2806, one or more mass storage device(s) 2808, one or more Input/Output (I/O) device(s) 2810, and a display device 2830 all of which are coupled to a bus 2812. Processor(s) 2802 include one or more processors or controllers that execute instructions stored in memory device(s) 2804 and/or mass storage device(s) 2808. Processor(s) 2802 may also include various types of computer-readable media, such as cache memory.

Memory device(s) 2804 include various computer-readable media, such as volatile memory e.g., random access memory (RAM) 2814) and/or nonvolatile memory (e.g., read-only memory (ROM) 2816). Memory device(s) 2804 may also include rewritable ROM, such as Flash memory.

Mass storage device(s) 2808 include various computer readable media, such as magnetic tapes, magnetic disks, optical disks, solid-state memory (e.g., Flash memory), and so forth. As shown in FIG. 28, a particular mass storage device is a hard disk drive 2824. Various drives may also be included in mass storage device(s) 2808 to enable reading from and/or writing to the various computer readable media. Mass storage device(s) 2808 include removable media 2826 and/or non-removable media.

I/O device(s) 2810 include various devices that allow data and/or other information to be input to or retrieved from computing device 2800. Example I/O device(s) 2810 include cursor control devices, keyboards, keypads, microphones, monitors or other display devices, speakers, printers, network interface cards, modems, lenses, CCDs or other image capture devices, and the like.

Display device 2830 includes any type of device capable of displaying information to one or more users of computing device 2800. Examples of display device 2830 include a monitor, display terminal, video projection device, and the like.

Interface(s) 2806 include various interfaces that allow computing device 2800 to interact with other systems, devices, or computing environments. Example interface(s) 2806 include any number of different network interfaces 2820, such as interfaces to local area networks (LANs), wide area networks (WANs), wireless networks, and the Internet. Other interface(s) include user interface 2818 and peripheral device interface 2822. The interface(s) 2806 may also include one or more user interface elements 2818. The interface(s) 2806 may also include one or more peripheral interfaces such as interfaces for printers, pointing devices (mice, track pad, etc.), keyboards, and the like.

Bus 2812 allows processor(s) 2802, memory device(s) 2804, interface(s) 2806, mass storage device(s) 2808, and I/O device(s) 2810 to communicate with one another, as well as other devices or components coupled to bus 2812. Bus 2812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 2800, and are executed by processor(s) 2802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The present disclosure is directed to methods, systems, and computer programs for using business credits. In this description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method comprising:
receiving, by a server system, selection of a selected brand-specific account of a plurality of brand-specific accounts of the user, each brand-specific account redeemable only for products branded according to a brand corresponding to the each brand-specific account;
transmitting, by the server system, to a user device of the user, representations of products branded according to the brand of the selected brand-specific account and having prices less than an amount of funds in the selected brand-specific account;
receiving, by the server system, a selection of a selected product branded according to the brand of the selected brand-specific account; and
transmitting, by the server system, an optical code to the user device, the optical code authorizing payment of a purchase price of the selected product toward purchase of the selected product.

2. The method of claim 1, further comprising:
requesting, by the server system, from a retailer server system, the representations of products branded according to the brand of the selected brand-specific account; and
receiving, by the server system, from the retailer server system, the representations of products branded according to the brand of the selected brand-specific account.

3. The method of claim 1, wherein the optical code is a universal product code (UPC).

4. The method of claim 1, wherein the optical code encodes the purchase price.

5. The method of claim 4, wherein the optical code encodes a product identifier of the selected product.

6. The method of claim 1, wherein the user device is a mobile computing device.

7. The method of claim 1, further comprising:
scanning, by a point of sale (POS) device, the optical code;
obtaining the purchase price using the optical code; and
applying the purchase price toward purchase of the selected product.

8. A method comprising:
receiving, on a user device, selection of a selected brand-specific account of a plurality of brand-specific accounts of the user, each brand-specific account redeemable only for products branded according to a brand corresponding to the each brand-specific account;
receiving, by the user device, representations of products branded according to the brand of the selected brand-specific account and having prices less than an amount of funds in the selected brand-specific account;
receiving, by the user device, a selection of a selected product branded according to the brand of the selected brand-specific account; and
transmitting, by the user device, a product identifier of the selected product to a server system;
receiving, by the user device, from the server system an optical code authorizing payment of a purchase price of the selected product toward purchase of the selected product.

9. The method of claim 8, further comprising:
requesting, by the server system, from a retailer server system, the representations of products branded according to the brand of the selected brand-specific account;
receiving, by the server system, from the retailer server system, the representations of products branded according to the brand of the selected brand-specific account; and
transmitting, by the server system, the representations of products branded according to the brand of the selected brand-specific account.

10. The method of claim 8, wherein the optical code is a universal product code (UPC).

11. The method of claim 8, wherein the optical code encodes the purchase price.

12. The method of claim 11, wherein the optical code encodes a product identifier of the selected product.

13. The method of claim 8, wherein the user device is a mobile computing device.

14. The method of claim 8, further comprising:
scanning, by a point of sale (POS) device, the optical code;
obtaining the purchase price using the optical code; and
applying the purchase price toward purchase of the selected product.

15. A system comprising one or more processors and one or more memory devices operably coupled to the one or more memory devices, the one or more memory devices storing executable and operational code effective to cause the one or more processors to:
receive selection of a selected brand-specific account of a plurality of brand-specific accounts of the user, each brand-specific account redeemable only for products branded according to a brand corresponding to the each brand-specific account;
transmit to a user device of the user, representations of products branded according to the brand of the selected brand-specific account and having prices less than an amount of funds in the selected brand-specific account;
receive a selection of a selected product branded according to the brand of the selected brand-specific account; and
transmit an optical code to the user device, the optical code authorizing payment of a purchase price of the selected product toward purchase of the selected product.

16. The system of claim 15, wherein the executable and operational code are further effective to cause the one or more processors to:
request from a retailer server system, the representations of products branded according to the brand of the selected brand-specific account; and
receive from the retailer server system, the representations of products branded according to the brand of the selected brand-specific account.

17. The system of claim 15, wherein the optical code is a universal product code (UPC).

18. The system of claim 15, wherein the optical code encodes the purchase price.

19. The system of claim 18, wherein the optical code encodes a product identifier of the selected product.

20. The system of claim 15, wherein the user device is a mobile computing device.
